(19) United States
(12) Patent Application Publication
(10) Pub. No.: US 2010/0315904 A1
(43) Pub. Date: Dec. 16, 2010

(54) DIRECTION-FINDING METHOD AND INSTALLATION FOR DETECTION AND TRACKING OF SUCCESSIVE BEARING ANGLES

(75) Inventors: Kevin BRINKMANN, Bremen (DE); Jörg Hurka, Oldenburg (DE); Martina Daun, Pillig (DE); Wolfgang Koch, Remagen-Rolandswerth (DE); Eicke Ruthotto, Bonn (DE)

Correspondence Address: FITCH, EVEN, TABIN & FLANNERY, P. O. BOX 18415, WASHINGTON, DC, 20036, US

(73) Assignee: Atlas Elektronik GmbH, Bremen (DE)

(21) Appl. No.: 12/793,227

(22) Filed: Jun. 3, 2010

(30) Foreign Application Priority Data
Jun. 9, 2009 (DE) 102009024339.9

(51) Int. Cl. G01S 15/00

(52) U.S. Cl. 367/99

(57) ABSTRACT

A direction-finding method and apparatus for detection and tracking of successive bearing angles of sound-emitting targets, wherein intensity plots of successive clock cycles in a waterfall plot show bearing traces of successive bearing angles, and preferred bearing traces are marked by a tracker. In order to automate the setting and deletion of trackers, starting from trace state vectors, which are determined at the time t=k−1, are each associated with one bearing trace and each have a bearing angle as well as its time derivative, which is referred to as the bearing rate, and possibly an intensity and its time derivative, which is referred to as the intensity rate, and trace errors associated with the trace state vectors for the time t=k, predicted state vectors are predicted together with predicted estimation errors. Bearing traces are displayed as a function of a trace quality

### CROSS REFERENCE TO RELATED APPLICATION

This application claims the priority of German patent application No. 10 2009 024 339.9-55, filed Jun. 9, 2009, the subject matter, in its entirety, is incorporated herein by reference.

### BACKGROUND OF THE INVENTION

The invention relates to a direction-finding method for detection and tracking of successive bearing angles of targets which emit broadband sound, over the entire azimuth panorama or a predeterminable azimuth sector, using a direction-finding installation for receiving broadband sound waves according to the precharacterizing clause of Claim 1, and to a direction-finding installation according to the precharacterizing clause of Claim 14.

In sonar technology, a passive direction-finding installation is used to monitor the entire azimuth or a sector, in order to detect noises from sound-emitting targets such as surface vessels, submarines, underwater vehicles or torpedoes, and to track bearing angles to the targets. The term “tracking” means the formation of a trace. The tracking of bearing angles therefore means the formation of one or more bearing traces for one or more targets. (with regard to the meaning of so-called “tracks” cf.: KOCH, W. “On Optimal Distributed Kalman Filtering and Retrodiction at Arbitrary Communication Rates for Maneuvering Targets”, in: IEEE International Conference on Multisensor Fusion and Integration for Intelligent Systems, 2008. MFI 2008. 20-22 Aug. 2008, p. 457-462.)

Electroacoustic or optoacoustic transducers in a receiving antenna in the direction-finding installation are used to form directional characteristics by means of which a bearing is taken via one of its main reception directions, which point in different adjacent directions, when the intensity, that is to say the amplitude or the level, of the associated array signal is above a predeterminable threshold, and the received noise is significantly greater than the ambient noise. Received signals received over a broad bandwidth by a predeterminable group or all the transducers in the receiving antenna are added with a propagation time delay or with phase compensation, and cophase to form an array signal, as a function of their position with respect to a reference line, the main reception direction of the directional characteristic associated with this array signal at right angles to the reference line indicating a bearing angle. For this purpose, the amplitudes or the levels, or in general the intensities, of the array signals are displayed via the bearing angle. A bearing to a target or a plurality of bearings to a plurality of targets is or are detected by means of a suitable detection algorithm, on the basis of these intensities of the array signals. This indication is continuously updated from one clock cycle to the next. When the target changes its course with respect to the direction-finding installation, the bearing to the target changes. In this case, if the target is approaching the direction-finding installation, the intensity of the array signal increases. If the target is moving away from the direction-finding installation, the intensity of the array signal decreases, until it is lost in the ambient noise.

A bearing trace is built up over time by displaying the array signals as a function of the bearing angle in successive intensity plots—following the angle profile of the array signals—and, because the intensity of this bearing trace is greater than the intensities of the surrounding array signals, this bearing trace is evident from the intensity plots. This bearing trace is then marked manually by a tracker, that is to say a mark or marking, in order to track the associated target via its bearings over time. The tracking of the target is ended manually, and the associated tracker is deleted, when the operator can no longer see any pronounced maximum in the angle-dependent display of the intensities of the array signals.

The invention is based on the object of specifying a direction-finding method and a direction-finding installation for detection and tracking of successive bearing angles, with targets being detected, trackers set and trackers deleted, automatically.

### SUMMARY OF THE INVENTION

According to the invention, this object is achieved by the features of Claims 1 and 14. It is possible to automate the detection of bearing angles and the marking of a bearing trace by the prediction according to the invention of a bearing angle and possibly of an intensity, in particular an amplitude or level, of a bearing trace and its association with a measured bearing angle, and possibly an associated intensity. It is in fact sufficient to carry out this prediction solely for the bearing angle. However, the prediction may additionally also be carried out for the intensity. The estimated bearing angle and/or the estimated intensity are/is advantageously displayed.

Bearing traces over time have a profile which generally corresponds essentially to an arctan function. According to the invention, these bearing traces are approximated by linear subelements in that, for in each case one subelement, the profile is predicted by an initial value, specifically the most recently determined bearing angle associated with the bearing trace, and the gradient of the subelement, until the next measurement of the bearing angle in a state vector, and a next bearing angle and possibly a next intensity on the bearing trace are/is predicted from this with an estimation error which takes account of a trace error which is associated with the most recently determined bearing angle and possibly with the most recently determined intensity. Since the measured bearing angles and possibly the measured intensities are subject to measurement errors, the approximation process according to the invention is likewise based on a noise process.

An association probability is then determined, with which a measured bearing angle and possibly a measured intensity can be associated with one of the bearing traces. A measured bearing angle and possibly a measured intensity together with a predicted bearing angle and possibly a predicted intensity for an estimated bearing angle and possibly an estimated intensity are then estimated as a function of a determined association probability by means of an estimation filter, in particular a Kalman filter. However, one bearing trace can also be associated with a plurality of bearing angles measured during one clock cycle and possibly with a plurality of intensities measured during the same clock cycle. The respective values (estimated values) estimated using these associations for the bearing angle and bearing rate and possibly for the intensity and the intensity rate are then added in a weighted form. The value or values determined in this way—that is to say for the situation in which a plurality of measured values relating to one bearing trace are associated with the weighted added values—is or are then associated with the trace state vector for the relevant bearing trace or in the case of an association with a plurality of bearing traces, with the trace state vectors of the relevant bearing traces. The values obtained in this way for an estimated bearing angle and possibly an estimated intensity are used together with the estimated bearing rate and possibly intensity rate as output variables of the state vector predicted in the next clock cycle for the relevant bearing trace. Bearing traces formed in this way are displayed as a function of a trace quality.

In the direction-finding method according to the invention, the prediction may relate to the bearing angle or to the bearing angle and the intensity. The same prediction algorithm is used for all predictions, and is based on the approximation of a time profile of a bearing trace with linear subelements as target motion model dynamics.

One advantage of the invention is automated initialization, extraction, confirmation and deletion of bearing traces without any operator action. A further advantage of the direction-finding method according to the invention is that a probably curved profile of a bearing trace can also be approximated by linear subelements, because of the density of the measured bearing angles over time. This is true even when the bearing angle to a target which is moving on a constant course and at a constant velocity with respect to the direction-finding installation does not change by a constant bearing rate for a constant movement interval of the target. The structuring of the model variances and the strength of the process noise result in an approximation which takes account of this behavior of the bearing angle.

In one advantageous development of the direction-finding method according to the invention, the quality is investigated with which the measured bearing angle and possibly the measured intensity fits the estimated bearing trace and whether the most recently estimated bearing angle can be displayed as an extension of the previous bearing trace. Taking account of a preset density for new bearing traces in the azimuth panorama or in the azimuth sector, and a preset density of false alarms, a trace quality is determined for each bearing trace, together with the association probability. This trace quality is added over a predeterminable number of clock cycles, and takes account of the entire history of the bearing trace, or of a part of the history of the bearing trace. The respectively currently calculated trace quality is compared with two bounds in order to use the bearing angle to initiate or to confirm a new provisional bearing trace, and to confirm or to delete an existing bearing trace. If there is no measured value, the most recent estimate is continued by prediction, and the trace quality is decreased. Superfluous measurements, with which no bearing trace can be associated, are assessed as the start of a new bearing trace. The bounds are defined by predeterminable probabilities for the confirmation of a false bearing trace or the deletion of a true bearing trace. The most recently determined bearing traces and their assessments are managed in a bearing trace list, and are displayed corresponding to the trace quality. These confirmed bearing traces can be marked, for example by color, and can thus be associated with a target.

In one advantageous development of the direction-finding method according to the invention, the bearing angle and possibly the trace intensity are determined from the predicted bearing angle and possibly the predicted intensity plus the difference of the measured and predicted bearing angle and possibly measured and predicted intensity, taking account of the estimation error and measurement error. This results in the bearing angle fitting the estimated bearing trace better the less the measured bearing angle and possibly the measured intensity differ from the estimated bearing angle and the estimated intensity, respectively, and the less the estimation error is.

In order to predict the next predicted state vector, according to one advantageous development of the direction-finding method according to the invention, the bearing rate determined from the previously estimated bearing trace, and possibly intensity rate or gradient of the bearing trace with respect to its angle profile and possibly its intensity, for the most recently determined bearing angle and possibly the most recently determined trace intensity are multiplied by the time interval and are added.

According to a further advantageous development of the invention, the estimation error is determined as a function of the most recently determined trace error, the model variances and the variance in the rate of change of the bearing rate and possibly intensity rate, and the covariance between the bearing angle and possibly the intensity and its rates of change. The estimation error becomes greater the greater the model variances are predetermined to be, and the greater the extent to which the estimated gradient differs from the previously determined gradient. By increasing the model variances, it is possible to associate the estimated bearing trace even with widely scattered measured bearing angles, and the bearing trace is not immediately terminated in the event of “spurious measured values” when, for example, the signal-to-noise ratio of the intensity fluctuates to a major extent, and no significant array signal is any longer received, for example because of changes in the transmission behavior in the propagation path of the sound waves between the target and the direction-finding installation.

The advantage of one development of the direction-finding method according to the invention is that the confidence of the bearing trace display can be varied by the upper bound on the trace quality. If the probability for confirmation of a false bearing trace is intended to be decreased, the upper bound is raised, and the number of confirmed bearing traces is reduced. This makes it possible to suppress bearing traces which are produced by reception of sound waves via sidelobes of the directional characteristic. Bearing traces from positions astern of the watercraft to which the direction-finding installation is attached, caused by the sound incidence of a propulsion propeller, are likewise suppressed.

In order to determine the quality of an estimated bearing trace with a predicted bearing angle and possibly predicted intensity, the squared, normalized statistical separation between each of the measured bearing angles and possibly intensity values and each predicted bearing angle and intensity value is determined, and is a measure of the association probability of the measured bearing angle or intensity value to the estimated bearing trace. The square of the difference between the measured and predicted bearing angle and/or intensity value as well as the sum of the associated errors comprising measurement errors and estimation errors are included in the determination of the squared, normalized statistical separation, with the probability becoming greater the smaller the difference between the bearing angle values or intensity values is, and the greater the model variances are predetermined and the permissible discrepancies from the predicted gradient and therefore the discrepancies from the estimated bearing trace are tolerated.

In order to reduce the required calculation capacity, according to a further advantageous development of the direction-finding method according to the invention, a gate value is introduced, by means of which pairs whose probability of association is below a predeterminable value are suppressed.

The quality with which the measured bearing angles are inserted into the previously estimated bearing traces is of interest. For this purpose, a trace quality is determined from the association probability, with the aid of a logarithmic likelihood quotient. The likelihood quotient is known from radar technology for tracks of target positions, and is described, for example, in Chapter 6 of the book “Design and Analysis of Modern Tracking Systems” by Samuel Blackman and Robert Popoli, Artec House, Boston, London, 1999. However, no target positions can be tracked in passive sonar installations, since only bearing angles are measured and the distance between the direction-finding installation and the target is unknown. The tracking direction-finding method according to the invention is based on tracking bearing angles which form a bearing trace when they are associated with one and the same target. Bearing angles and possibly trace intensities are estimated using the predicted bearing angles and possibly intensities, and bearing rates and possibly intensity rates, together with measured bearing angles and possibly intensities, and bearing traces are determined therefrom, and are displayed.

In order to determine the quality of the bearing traces, a detection probability P_{D} is predetermined for a new real bearing angle in the angle separation between the main reception directions of adjacent directional characteristics, for example corresponding to an empirical density of newly detected bearing angles in each clock cycle in the entire azimuth panorama or in the azimuth sector, is converted to logarithmic form and one quality increment for the bearing trace is added in each clock cycle. The quality increment contains the ratio, in logarithmic form, of the detection probability and a predetermined false alarm probability which, for example, is determined from an empirical density of false alarms in the azimuth panorama or azimuth sector for a bearing angle in the angle separation between the main reception directions. Taking account of the sum of measurement errors and estimation errors, this logarithm forms a first term of the quality increment, from which half the square of the normalized statistical separation between the measured and predicted bearing angles is subtracted for each bearing trace in each clock cycle. All or a predeterminable number of most recently determined quality increments which belong to the same bearing trace form the trace quality.

The advantages of the hardware embodiment of the invention with a direction-finding installation correspond to those which have been stated in conjunction with the direction-finding method according to the invention. Different direction-finding sensors can be used in this case, which each comprise a receiving antenna and a beamformer. The receiving antenna is designed for different reception frequency ranges and, for example, comprises a cylindrical base, a flank antenna, a towed antenna, a so-called conformal array or conformal transducer arrangement, or a planar array or planar transducer arrangement, as well as their downstream signal processing algorithms, as stated in DE 10 2007 019 445. The array signals from the beamformer are evaluated in the direction-finding installation according to the invention, and are used in order to track targets by tracking their bearing traces.

It is particularly advantageous for the signal processing according to the invention to use a Kalman filter for the modeling of the linear approximation of the bearing trace, the prediction of the bearing angle and possibly intensity from most recently determined bearing angles and possibly trace intensities and their estimation errors, and for determining the instantaneous bearing angle and trace error. The probability of association of a measured bearing angle and predicted bearing angle, in pairs, is determined in a separation calculation stage, taking account of measurement errors and estimation errors, using the global nearest neighbor method (GNN method). This global nearest neighbor method is described in DE 10 2007 019 445 for testing the association of bearing traces which are produced by different sensors in a direction-finding installation. The advantage is, in particular, that the most probable association is found easily by means of the cost matrix specified there, using the JVC method (Jonker, Volgenant, Castañon). The squared, normalized statistical separation between a measured bearing angle and a predicted bearing angle is produced at the output of the separation calculation stage.

The probability of association of a measured bearing angle with an estimated bearing trace corresponding to its squared, normalized statistical separation at the output of the separation calculation stage is used in a trace quality calculator to determine a trace quality in a downstream calculation stage, by determining the likelihood quotient of each bearing trace. This trace quality is compared in a bound comparison arrangement of the trace quality calculator with an upper and a lower bound. If the trace quality is above an upper bound, which is determined by predetermined probabilities for the confirmation of a false bearing trace or the deletion of a true bearing trace, the bearing trace has a high quality, and if it is less than a lower bound, which is formed from the same probabilities, the bearing trace is deleted. If the trace quality is between the bounds, then the provisional, estimated bearing trace is either confirmed by further measurements and the trace quality increases above the upper bound, with the bearing trace becoming a confirmed bearing trace, or it is not confirmed and the trace quality falls, until it falls below the lower bound, and the provisional bearing trace is deleted. It is likewise possible to display and to mark the entire length of a provisional bearing trace whose trace quality is above the upper bound T₂ in the most recent clock cycle, such that these bearing angles, which have already occurred, can be added in accordance with a so-called target motion analysis, for example in order to passively determine the distance to the target, as is stated, for example, in DE 10 2007 019 445. For this purpose, the bound comparison arrangement at the output of the trace quality calculator is connected to the register for the bearing traces, in which the bearing angles of each bearing trace at the output of the Kalman filter are registered, together with the trace quality. The output of the bound comparison arrangement likewise controls a port which is provided between the register and a display, in order to display confirmed bearing angles as a continuation of the associated bearing trace in an intensity plot, in each clock cycle.

Further advantageous embodiments of the direction-finding method according to the invention and of the direction-finding installation according to the invention will become evident from the dependent claims and from the exemplary embodiments which will be explained in more detail with reference to the drawing.

### BRIEF DESCRIPTION OF THE DRAWINGS

FIG. 1 shows a bearing/time diagram with one bearing trace.

FIG. 2 shows a block diagram of a direction-finding installation.

FIG. 3 shows the profile of a trace quality plotted against time,

FIG. 4 shows a block diagram in order to explain the data flow in a second exemplary embodiment of the invention, using a multihypothesis tracking method.

FIG. 5 shows a diagram in order to explain the data flow in the block annotated MHT in FIG. 4.

### DETAILED DESCRIPTION OF THE INVENTION

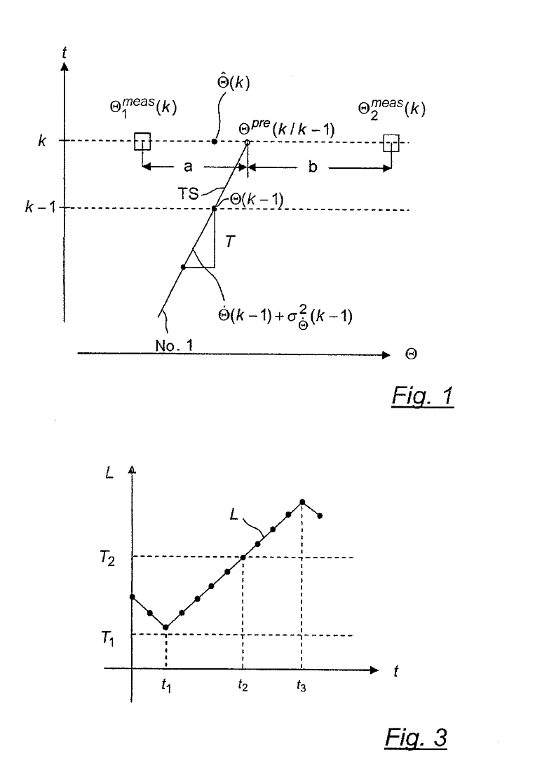

FIG. 1 shows a bearing/time diagram in which the bearing Θ, plotted along the horizontal axis, is shown against time, plotted along the vertical axis. This diagram shows a subelement TS of a bearing trace No. 1, which is estimated up to the time t=k−1 and is obtained by prediction of the bearing angle for the time t=k. For this purpose, starting from a bearing angle Θ(k−1) for the time t=k−1 on the bearing trace No. 1, a bearing angle Θ^{pre}(k/k−1) is predicted for the time t=k, based on historical measurement data up to the time t=k−1. The subelement TS has a linear profile over time. The bearing rate or gradient of the bearing trace \dot{Θ}(k−1) for the time t=k−1 is determined by regression analysis from the sequence of the associated measurements up to the time t=k−1, using a standard deviation σ_{\dot{Θ}}(k−1). The two bearing angles Θ₁^{meas}(k) and Θ₂^{meas}(k) measured at t=k are tested using the predicted bearing angle Θ₁^{pre}(k/k−1) for association in pairs with the bearing trace No. 1. The first measured bearing angle Θ₁^{meas} is at the distance a=Θ₁^{meas}(k)−Θ^{pre}(k/k−1), the second measured bearing angle Θ₂^{meas} is at the distance b=Θ₂^{meas}(k)−Θ^{pre}(k/k−1) from the predicted bearing angle Θ^{pre}(k/k−1). First of all, the probabilities of possible association of each of the measured bearing angles with the predicted bearing angle are determined by means of the distances a and b and measurement and estimation errors with the aid of a squared, normalized statistical separation. In the illustrated example, this distance is less for the pair comprising the measured bearing angle Θ₁^{meas}(k) and the predicted bearing angle Θ^{pre}(k/k−1) than for the pair comprising the measured bearing angle Θ₂^{meas}(k) and Θ^{pre}(k/k−1). The probability of the association of the measured bearing angle Θ₁^{meas} with the bearing trace No. 1 is therefore a maximum, as a result of which the measured bearing angle Θ₁^{meas} is associated with the bearing trace No. 1. A bearing angle \hat{Θ}(k/k) for the time t=k is then estimated by means of an estimation filter, on the basis of this association, that is to say taking account of the measured bearing angle Θ₁^{meas} and the predicted bearing angle Θ^{pre}(k/k−1). By way of example, this estimation filter is in the form of a Kalman filter, which also carries out the abovementioned prediction. On the basis of this estimated bearing angle \hat{Θ}(k), the next bearing angle Θ^{pre}(k+1/k) after a further clock cycle T is predicted for the time t=k+1 for the bearing trace No. 1. This process is illustrated in a following block diagram.

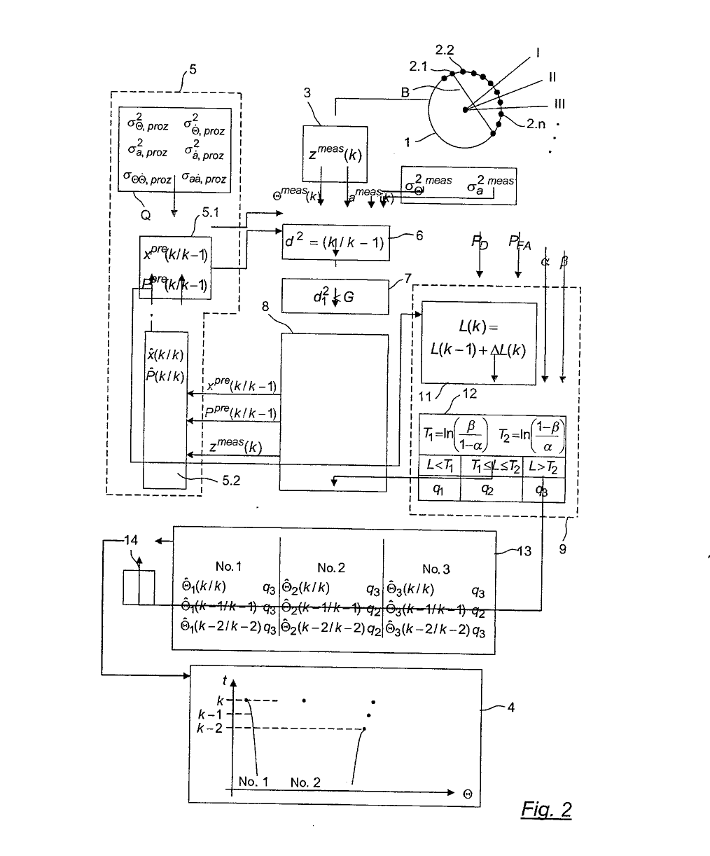

FIG. 2 shows a block diagram of a direction-finding installation. The cylindrical receiving antenna 1 forms directional characteristics in main reception directions I, II, III . . . , which are separated by an angle ΔΘ from one another. Signals received by electroacoustic transducers 2.1 to 2.n are each added cophase in a beamformer 3 after a propagation time delay, governed by distances between each transducer 2.1 to 2.n and a reference line B, to form array signals of the directional characteristics, and, depending on the directional characteristic, produce an amplitude a^{meas} and a bearing angle Θ^{meas}. Instead of the amplitude, it is also possible to use a corresponding level or, in a general form, the intensity of the signal. Measured amplitude and measured bearing angle form elements of a measurement vector. Intensity plots of the intensity (amplitude or level) of array signals from adjacent directional characteristics are displayed on a display 4 in each clock cycle T as a function of their main reception direction as bearing angles Θ for detection of bearing angles which indicate the direction to sound-emitting targets, and for tracking the bearing angles of the same target over time. Successive intensities over the same bearing angle identify the bearing trace of a target (target trace) which is approaching the direction-finding beam of the direction-finding installation, or is moving away from the direction-finding installation. Successive intensities of a target moving past, as a bearing trace, have an arctan profile over the bearing angle, in which case the bearing angle changes little over time when the target is a long distance away, and the bearing rate \dot{Θ} is therefore low. As the target moves past, the bearing rate \dot{Θ} has a greater value, and as the target moves away it once again assumes a lower, virtually constant value. Up to t=k−1, the bearing trace No. 1 exhibits a virtually constant bearing angle, and the bearing rate \dot{Θ} is very low. Subsequently, the bearing angle Θ changes, and the bearing rate \dot{Θ} assumes a different value. The displayed bearing trace No. 2 does not start until t=k, because a target was detected at this time. The bearing trace No. 3 ends at t=k−2, since the bearing trace was deleted at this time.

The direction-finding method according to the invention and the direction-finding installation according to the invention are used to predict the bearing angles of these bearing traces on the model assumption that subelements of the bearing traces are linear and that their gradient is constant in places, that is to say the bearing rate is constant. The prediction is made by estimating a state vector with an estimation error which is predetermined by model variances σ_{Θ, proz}², σ_{\dot{Θ}, proz}² and σ_{a, proz}², σ_{\dot{a}, proz}² in a covariance matrix Q in a Kalman filter 5. The stiffness of the filter is set by means of the preset or variable strength q with q_{Θ} for the bearing angle and qₐ for the amplitude of a noise process. The covariance matrix Q therefore becomes:

$$\begin{matrix}Q = [ \begin{matrix}{f}_{1} ( T ) {q}_{Θ} & {f}_{2} ( T ) {q}_{Θ} & 0 & 0 \\ {f}_{2} ( T ) {q}_{Θ} & {f}_{3} ( T ) {q}_{Θ} & 0 & 0 \\ 0 & 0 & {f}_{1} ( T ) {q}_{a} & {f}_{2} ( T ) {q}_{a} \\ 0 & 0 & {f}_{2} ( T ) {q}_{a} & {f}_{3} ( T ) {q}_{a}\end{matrix} ] \\ = [ \begin{matrix}{σ}_{Θ , proz}^{2} & {σ}_{Θ \dot{Θ} , proz}^{2} & 0 & 0 \\ {σ}_{Θ \dot{Θ} , proz}^{2} & {σ}_{\dot{Θ} , proz}^{2} & 0 & 0 \\ 0 & 0 & {σ}_{a , proz}^{2} & {σ}_{a \dot{a} , proz}^{2} \\ 0 & 0 & {σ}_{a \dot{a} , proz}^{2} & {σ}_{\dot{a} , proz}^{2}\end{matrix} ]\end{matrix} \\ where \begin{matrix} {f}_{1} ( T ) = \frac{{T}^{3}}{3} & {f}_{3} ( T ) = T & {f}_{2} ( T ) = \frac{{T}^{2}}{2} .\end{matrix}$$

A state vector x^{pre}(k/k−1) to the instantaneous time relating to the time t=k is predicted in a prediction part 5.1 of the Kalman filter 5 on the basis of a trace state vector \hat{x}(k−1/k−1) with its elements of estimated bearing angles \hat{Θ}(k−1/k−1) and estimated trace amplitude â(k−1/k−1) and their rates of change at the present time for the time t=k−1, as:

$${x}^{pre} ( k / k - 1 ) = [ \begin{matrix}{Θ}^{pre} ( k / k - 1 ) \\ {\dot{Θ}}^{pre} ( k / k - 1 ) \\ {a}^{pre} ( k / k - 1 ) \\ {\dot{a}}^{pre} ( k / k - 1 )\end{matrix} ] = F \cdot x ( k - 1 / k - 1 )$$

with the predicted bearing angle

Θ^{pre}(k/k−1)=\hat{Θ}(k−1/k−1)+{dot over (\hat{Θ}(k−1/k−1)·T

and the predicted bearing angle rate

\dot{Θ}^{pre}(k/k−1)={dot over (\hat{Θ}(k−1/k−1)

and the predicted amplitude

a^{pre}(k/k−1)=\hat{a}(k−1/k−1)+\dot{â}(k−1/k−1)·T

and its predicted time derivative, which is referred to as the amplitude rate:

\dot{a}^{pre}(k/k−1)=\dot{â}(k−1/k−1),

which takes account of the modeling of the subelement, with a covariance matrix of the estimation error:

$${P}^{pre} ( k / k - 1 ) = F \cdot P ( k - 1 / k - 1 ) {F}^{T} + Q where$$

$$F = [ \begin{matrix}1 & T & 0 & 0 \\ 0 & 1 & 0 & 0 \\ 0 & 0 & 1 & T \\ 0 & 0 & 0 & 1\end{matrix} ]$$

as a transition matrix for the dynamic process of modeling.

Installation-typical measurement errors σ_{Θ}^{meas}, σₐ^{meas} are determined for the measurement vector

$${z}^{meas} ( k ) = [ \begin{matrix}{Θ}^{meas} ( k ) \\ {a}^{meas} ( k )\end{matrix} ]$$

at the output of the beamformer 3, which contains all the bearing angles Θ^{meas}(k) and amplitudes α^{meas}(k) measured for the time t=k, which measurement errors are examined together with the predicted bearing angle Θ^{pre}(k/k−1) and the predicted amplitude a^{pre}(k/k−1) and the respective estimation error P^{pre}(k/k−1) in a separation calculation stage 6, for the probability of their association in pairs with a predicted bearing trace. For this purpose, a squared, normalized statistical separation d₁²

d₁²(k/k−1)=y^{T}(k/k−1)·S⁻¹(k/k−1)·y(k/k−1) where

y(k/k−1)=z(k)−H\hat{x}^{pre}(k/k−1)

is determined between all the pairs of bearing angles and amplitudes, with the sum of the squared bearing angle difference and of the squared amplitude difference y being related to the error sum S(k/k−1) of the measurement error R and the estimation error P^{pre}(k/k−1) predicted from t=k−1 to t=k, and the probability of association is a maximum when the squared, normalized statistical separation d₁² is a minimum. The association algorithm used there is known as the GNN method, and is described using a cost matrix calculation in DE 10 2007 019 445.

The separation calculation stage 6 is followed by a gate circuit 7, by means of which pairs with an excessively low association probability are deleted. For this purpose, the normalized statistical separation d₁² is compared with a gate value G

$$G = 2 \cdot ln \frac{{P}_{D} \cdot ΔΘ}{( 1 - {P}_{D} ) \cdot {( 2 π )}^{M / 2} {P}_{FA} \sqrt{\vert S \vert}}$$

which takes account of the sum S of the measurement errors and estimation errors. In this case, M denotes the dimensionality of the measurement vector which, when the bearing is used exclusively, is 1, when the bearing and the intensity are used is 2, and which is 3 when using the bearing, the intensity and the frequency. Furthermore, in order to preset the gate value G, a detection probability P_{D} of detection of a target with a directional characteristic is selected from a density β_{NT} to be expected of newly detected bearing angles in each time interval T in the azimuth panorama or azimuth sector of the direction-finding installation, and a false alarm probability P_{FA} is selected from a density β_{FT} to be expected of false alarms taking account of the angle separation ΔΘ between the main reception directions of two adjacent directional characteristics. This also applies to the amplitudes.

The pairs comprising the measurement vector z^{meas}(k), the predicted state vector x^{pre}(k/k−1) and their errors are supplied by means of a subsequent measurement data association stage 8 to a filter stage 5.2 in the Kalman filter 5.

The trace state vector \hat{x}(k/k) for the time t=k is determined in the filter stage 5.2 from the predicted state vector x^{pre}(k/k−1) and its estimation error P^{pre}(k/k−1) and the measured values z^{meas}(k) and a measurement covariance matrix R for the time t=k for each bearing trace

\hat{x}(k/k)=x^{pre}(k/k−1)+K(k)[z(k)−Hx^{pre}(k/k−1)]

with the measurement matrix

$$H = [ \begin{matrix}1 & 0 & 0 & 0 \\ 0 & 0 & 1 & 0\end{matrix} ]$$

and the matrix

K(k)=P^{pre}(k/k−1)H^{T}[H·P^{pre}(k/k−1)·H^{T}+R]⁻¹

as well as the covariance matrix of the trace error to be

\hat{P}(k/k)=[I−K(k)H]·P^{pre}(k/k−1)·[I−K(k)H]^{T}+K(k)·R·K(k)^{T}

with the unit matrix I.

This trace state vector \hat{x}(k/k) forms the basis for the prediction of the next state vector x^{pre}(k/k+1) and the estimation error P^{pre}(k/k+1) for the time t=k+1.

A trace quality calculator 9 comprises a calculation stage 11 for determining a trace quality L from a likelihood quotient, in logarithmic form, and a bound comparison device 12 for testing the trace quality L, to determine whether the associated bearing trace is confirmed and displayed by the bearing angle Θ(k) and the trace amplitude a(k), or should be checked further or deleted. The calculation stage 11 is connected on the input side to the output of the filter stage 5.2 of the Kalman filter 5, and receives the filtered or estimated state vector \hat{x}(k/k) and the covariance matrix \hat{P}(k/k) as input variables, the measurement covariances σ_{Θ}^{2meas}, σₐ^{2meas} and the square of the estimation errors σ_{\hat{Θ}}²(k/k−1), σ_{â}²(k/k−1).

The current trace quality

L(k)=L(k−1)+ΔL

is determined in the calculation stage 11 from the trace quality of the previous clock cycle and a quality increment ΔL for the association of the measured bearing angle with the relevant bearing trace, in which case this quality increment ΔL is calculated to be:

$$Δ L = ln \frac{{P}_{D} \cdot ΔΘ}{{P}_{FA} \sqrt{\vert S \vert}} - \frac{{d}^{2} ( k / k - 1 ) + M \cdot ln 2 π}{2}$$

which is determined for each clock cycle T from the squared, normalized statistical separation d₁² at the output of the separation calculation stage 6 and the square root of the sum of the measurement variance σ^{2meas} and estimation variances σ_{\hat{Θ}}²(k/k−1) and σ_{â}²(k/k−1). As explained above, M in this case denotes the dimensionality of the measurement vector. The trace quality L is increased or decreased by the associated quality increment ΔL in each clock cycle T.

A lower bound T₁

$${T}_{1} = ln ( \frac{β}{1 - α} )$$

and an upper bound T₂

$${T}_{2} = ln ( \frac{1 - β}{α} )$$

are defined in the bound comparison arrangement 12 from a predetermined probability α for the confirmation of a false bearing trace and a predetermined probability β for the deletion of a true bearing trace, and the trace quality L is compared with these bounds.

If the upper bound T₂ is exceeded, a provisional bearing trace is confirmed and displayed; if the lower bound T₁ is undershot, a provisional bearing trace is deleted. Provisional bearing traces whose qualities are between these bounds are stored until they exceed the upper bound or fall below the lower bound. Each measurement which cannot be associated is classified as the start of a bearing trace. If the trace quality of a confirmed bearing trace decreases because of the lack of measurements, the bearing trace is deleted when the trace quality has fallen by a predetermined value.

The probability α is based on the knowledge of the false alarm rate per second and the desired mean number of confirmations of false bearing traces per second, and becomes smaller, the fewer false bearing traces are permitted. The upper bound T₂ is therefore high when the probability α is low, that is to say when only a small number of false bearing traces are permitted.

The trace qualities produced at the output of the trace quality calculator 9 as well as the values, estimated by means of the filter stage 5.2 of the Kalman filter 5, supplied to the trace quality calculator 9 and produced at its output, for the bearing angle and the trace amplitude are stored for each bearing trace in a register 13 and are passed on via a port 14 to the display 4, where they are displayed with a marking when the trace quality is above the upper bound T₂. It is likewise possible to display and to mark the entire length of a provisional bearing trace whose trace quality in the last clock cycle exceeded the upper bound T₂, such that these bearing angles which occurred in the past can also be used for passive determination of the distance to the target, using target motion analysis, as is stated, for example, in DE 10 2007 019 445.

FIG. 3 shows a typical profile of a trace quality L plotted against time t. The lower bound T₁ and the upper bound T₂ are shown. The bearing trace is deleted when the trace quality L falls below the bound T₁. Trace qualities which are between the bounds indicate provisional bearing traces which are stored as such in the register. They are displayed only when the associated trace quality L exceeds the upper bound T₂, and from then on form a confirmed bearing trace.

The trace quality L of a provisional bearing trace as shown in FIG. 3 falls until the time t₁, and approaches the lower threshold T₁, but without reaching it, and then rises again, but first of all without exceeding the threshold T₂. During this, it is managed as a provisional bearing trace. At the time t₂, the trace quality L exceeds the upper bound T₂, and the provisional bearing trace becomes a confirmed bearing trace. When the trace quality L falls by a predetermined value, for example starting from the time t₃, for example because the target can no longer be detected within a time period, the trace is deleted.

In order to initialize the direction-finding method according to the invention or the apparatus according to the invention, the first array signals are formed at the time t=1, producing first measurement vectors z(1) with m₁ measured bearing angles and possibly amplitudes. A provisional bearing trace is started for each measured bearing angle or measured amplitude, and a state vector \hat{x}(1) is determined, where

\hat{Θ}(1)=Θ^{meas}(1) and \hat{a}(1)=a^{meas}(1).

The estimation error is predetermined by:

\hat{P}(1)=P₀.

The trace quality is L(1)=0. The Kalman filter 5 is started using these input variables.

mₖ measurement vectors z(k) are measured for the time t=k. State vectors

$${x}^{pre} ( k / k - 1 ) = [ \begin{matrix}{Θ}^{pre} ( k / k - 1 ) \\ {\dot{Θ}}^{pre} ( k / k - 1 ) \\ {a}^{pre} ( k / k - 1 ) \\ {\dot{a}}^{pre} ( k / k - 1 )\end{matrix} ]$$

are predicted and the association in pairs with the present bearing traces is found in the separation calculation stage 6, and these are processed in the Kalman filter 5, if the probability is sufficiently high. The trace quality L of each bearing trace is determined in the trace quality calculator 9, and the provisional bearing traces are noted in the register 13. New measurements initiate provisional bearing traces. Provisional bearing traces become confirmed bearing traces, or are deleted, as a function of the trace qualities determined over the course of the clock cycles. If there is no new measurement for a predicted bearing trace, then the most recently determined state vectors and state errors are predicted in the next clock cycle.

According to the direction-finding method described above, broadband signal processing is carried out, in which essentially all the sound energy emitted over a wide frequency range is considered in every detection. Information which is contained in frequencies of the incident sound energy is therefore not considered any further. A detection is therefore described by a measurement vector which is restricted to a measured bearing angle and a measured intensity.

However, alternatively, signal processing is carried out in a narrow bandwidth, with a distinction being drawn between so-called DEMON signal processing and so-called LOFAR signal processing. In the case of DEMON signal processing, the total sound intensity recorded in one clock cycle per direction is examined for the presence of amplitude modulation. Possible target detections are found from the respective modulation spectra for all directional characteristics using an algorithm, with detection comprising the bearing associated with the target, a modulation frequency and the intensity of the frequency line.

In so-called LOFAR signal processing, the entire sound intensity recorded in one clock cycle per direction is examined for frequencies that occur. One algorithm finds possible target detections for each directional characteristic, with a detection comprising the bearing to the target, the frequency and the intensity of the corresponding frequency line.

In addition, frequency information can be considered in narrowband signal processing. For this purpose, a detection is given by a measurement vector which includes a frequency as well as a bearing and an intensity.

In consequence, the trace state vector in the case of broadband signal processing comprises only a bearing angle, as well as its time derivative, which is referred to as the bearing rate, and an intensity as well as its time derivative, which is referred to as the intensity rate. In contrast, the trace state vector for narrowband signal processing additionally comprises a frequency as well as its time derivative, which is referred to as the frequency rate. In consequence, in the case of narrowband signal processing, the covariance matrix Q has variances added to it which are related to the frequency and the frequency rate.

The direction-finding method which has been explained above with reference to FIGS. 1 to 3 assumes that a detection or measurement is in each case associated with only one individual bearing trace. This method is therefore also referred to as the single-hypothesis tracking method, with the hypothesis referring to the assumption that a measurement is associated with one specific bearing trace.

Alternatively, however, the invention also provides for the use of a multi-hypothesis tracking method, in which one measurement is normally associated with a plurality of target traces.

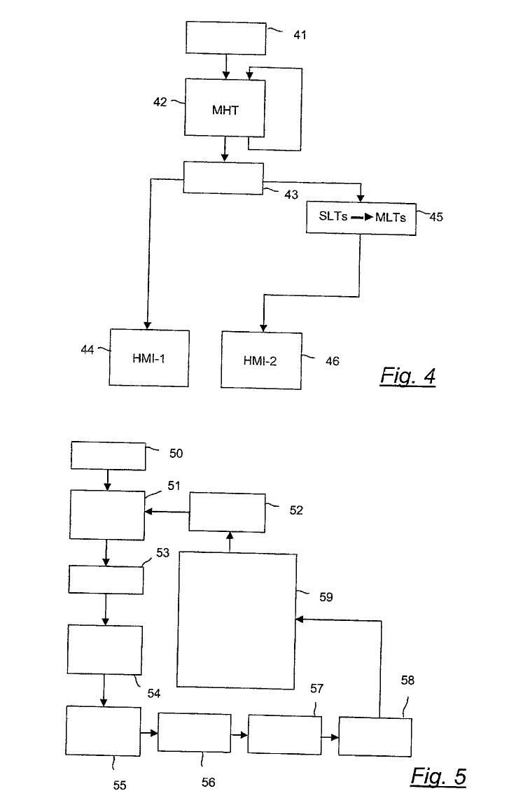

FIG. 4 shows, in principle, the data flow for a method such as this. Measurement data produced from a sonar installation is read in block 41, producing a list of detections for each clock cycle, depending on whether the signal processing is carried out with a narrow or broad bandwidth. In the case of broadband signal processing, this therefore results in a measurement vector:

$${z}_{j} ( k ) = [ \begin{matrix}{θ}_{j}^{meas} ( k ) \\ {a}_{j}^{meas} ( k )\end{matrix} ]$$

and in the case of narrowband signal processing, a measurement vector:

$${z}_{j} ( k ) = [ \begin{matrix}{θ}_{j}^{meas} ( k ) \\ {v}_{j}^{meas} ( k ) \\ {a}_{j}^{meas} ( k )\end{matrix} ] .$$

The index j in this case denotes a measurement obtained at the time t=k of a total of m(k) measurements, where j=1, . . . , m(k). The detections obtained also contain false alarms, however, in addition to the true target detections. The measurement data is preferably read together with the current value of the own course by means of a data read module in the block 41 from the sonar installation, thus resulting in the following lists of m(k) detections for the k-th clock cycle, for broadband signal processing:

$$\begin{matrix}1 \text{:} & {θ}_{1}^{meas} ( k ) , & {a}_{1}^{meas} ( k ) \\ 2 \text{:} & {θ}_{2}^{meas} ( k ) , & {a}_{2}^{meas} ( k ) \\ & ⋮ & ⋮ \\ m ( k ) \text{:} & {θ}_{m ( k )}^{meas} ( k ) , & {a}_{m ( k )}^{meas} ( k )\end{matrix}$$

and for narrowband signal processing:

$$\begin{matrix}1 \text{:} & {θ}_{1}^{meas} ( k ) , & {v}_{1}^{meas} ( k ) & {a}_{1}^{meas} ( k ) \\ 2 \text{:} & {θ}_{2}^{meas} ( k ) , & {v}_{2}^{meas} ( k ) & {a}_{2}^{meas} ( k ) \\ & ⋮ & ⋮ & ⋮ \\ m ( k ) \text{:} & {θ}_{m ( k )}^{meas} ( k ) , & {v}_{m ( k )}^{meas} ( k ) & {a}_{m ( k )}^{meas} ( k )\end{matrix}$$

This data, which corresponds to the components of the respective abovementioned measurement vector, is then passed on together with the own course to a multi-hypothesis tracking block 42. The purpose of this block is to extract potential target traces from the data by checking all detections (in their time sequence) to determine whether they can be associated with a target with a specific predetermined motion characteristic. If detections such as these, which correspond in time with a motion model, are found, a target state estimation process is carried out. Specifically, the motion state of a target is described in the tracking system by a state vector (to be estimated) and an equation for modeling the rate of change of the state vector. The state vector xᵢ(k) of the i-th target in the k-th clock cycle in addition contains not only estimates of the variables which are present in the respective abovementioned measurement vector but also estimates of their rate of change, that is to say, for the estimated bearing Θ, the bearing rate formed by the time derivative, for the frequency ν, the frequency rate \dot{ν} formed by the time derivative, for the amplitude a, the amplitude rate \dot{a} formed by the time derivative. For broadband signal processing, the state vector therefore becomes:

$${x}_{i} ( k ) = [ \begin{matrix}{Θ}_{i} ( k ) \\ {\dot{Θ}}_{i} ( k ) \\ {a}_{i} ( k ) \\ {\dot{a}}_{i} ( k )\end{matrix} ]$$

and for narrowband signal processing, it becomes:

$${x}_{i} ( k ) = [ \begin{matrix}{Θ}_{i} ( k ) \\ {\dot{Θ}}_{i} ( k ) \\ {v}_{i} ( k ) \\ {\dot{v}}_{i} ( k ) \\ {a}_{i} ( k ) \\ {\dot{a}}_{i} ( k )\end{matrix} ] .$$

The change in the state vector is modeled by a linear Markov process using the equation:

xᵢ(k)=Fxᵢ(k−1)+qᵢ(k−1)

where F represents the transfer matrix and qᵢ(k−1) an implementation of a Gaussian random process with a mean value 0 and a known covariance matrix Qᵢ(k−1) (for the case of a white noise process). The transfer matrix F and the process noise covariance Qᵢ(k−1) result from the choice of the maneuver model. A model is preferably chosen which describes uniform linear movement of the targets on which the observation variables are based.

A measurement of an object is described by the measurement process, formally by the equation

zⱼ(k)=Hxⱼ(k)+vⱼ(k).

In the measurement equation, H is the measurement matrix which characterizes the projection from state space to measurement space (and which is defined from knowledge of the state vector and the measurement vector) and vⱼ(k) the implementation of a white noise process with a mean value of 0 and a covariance matrix Rⱼ(k), where the measurement errors of the individual variables are considered to be uncorrelated. The measurement error covariance is therefore in the following form for broadband signal processing:

$${R}_{j} ( k ) = [ \begin{matrix}{σ}_{{θ}^{meas}}^{2} & 0 \\ 0 & {σ}_{{a}^{meas}}^{2}\end{matrix} ]$$

and for narrowband signal processing:

$${R}_{j} ( k ) = [ \begin{matrix}{σ}_{{θ}^{meas}}^{2} & 0 & 0 \\ 0 & {σ}_{{v}^{meas}}^{2} & 0 \\ 0 & 0 & {σ}_{{a}^{meas}}^{2}\end{matrix} ]$$

where σₓ, xε{θ^{meas}, ν^{meas}, α^{meas}} can be predetermined as selectable parameters. For the situation in which the antenna used to produce the detection lists is a linear antenna, it is possible to assume a bearing error σ_{θ}_{^{mess}}, which is dependent on the current measurement zⱼ(k), that is to say a bearing measurement error, according to the equation:

$${σ}_{{θ}^{mess}} = \frac{{σ}_{θ}^{0}}{\vert sin ( {θ}_{j}^{meas} ( k ) - {θ}_{0} ( k ) ) \vert \cdot \sqrt{{a}_{j}^{meas} ( k )}} .$$

In this case, θⱼ^{meas} (k) denotes the bearing and αⱼ^{meas}(k) denotes the amplitude of the measurement, θ₀(k) the own course of a watercraft which is fitted with or is towing the direction-finding antenna, and σ_{θ}⁰ a selectable constant.

The multi-hypothesis tracking block 42 uses a predetermined process model and a predetermined measurement model to generate a number of target traces which, referred to in the following text as tracks or traces, can be split into confirmed and provisional tracks by means of a sequential likelihood quotient test. The essence of the multi-hypothesis tracking method is a track list of the provisional and confirmed tracks. A track i in the k-th clock cycle comprises the state vector xᵢ(k), an indication of the estimation error in the form of the covariance matrix Pᵢ(k), an overall probability cᵢ(k), a status indicator SAᵢ(k) in order to indicate whether the relevant track is confirmed, it is indicated by the value “1”, or is provisional, it is indicated by the value “0”, a counter ZÄᵢ(k), which is incremented (or decremented) dependent on whether the track i passes (or does not pass) the sequential likelihood quotient test in the k-th clock cycle and an indicator INᵢ(k) which indicates the track j with which a confirmed track i has a resolution conflict.

A resolution conflict will be defined, for example, for the case of broadband signal processing. If there are two targets on the same bearing, it is no longer possible to detect them separately. Target trace crossings occur frequently, in which the bearings of two targets approach one another at an ever greater extent, then therefore resulting in a resolution conflict.

If the indicator INᵢ(k)=0, there is no resolution conflict. The covariance matrix Pᵢ(k) contains the variances of the estimation errors of the individual components of the state vector on the main diagonal, and the covariances of the estimation errors between different components in the non-diagonal elements. The state vector and the covariance of each track i are approximated by a weighted sum of a plurality of individual state vectors which touch, by allowing a plurality of interpretation hypotheses in this method, for association of measurement data with an already existing target trace. If, for example, track i in the clock cycle k comprises n_{i,hyp}(k) hypotheses with the weights c_{i,j}(k), j=1, . . . , n_{i,hyp}(k), where n_{i,hyp}(k) is a natural number, then the overall probability for the track in the k-th clock cycle becomes:

$${c}_{i} ( k ) = {\sum }_{j = 1}^{{n}_{i , hyp} ( k )} {c}_{i , j} ( k )$$

the state vector becomes:

$${x}_{i} ( k ) = \frac{1}{{c}_{i} ( k )} {\sum }_{j = 1}^{{n}_{i , hyp} ( k )} {c}_{i , j} ( k ) {x}_{i , j} ( k )$$

and the covariance becomes:

$${P}_{i} ( k ) = \frac{1}{{c}_{i} ( k )} {\sum }_{j = 1}^{{n}_{i , hyp} ( k )} {c}_{i , j} ( k ) [ \begin{matrix}{P}_{i , j} ( k ) + ( {x}_{i , j} ( k ) - {x}_{i} ( k ) ) \cdot \\ {( {x}_{i , j} ( k ) - {x}_{i} ( k ) )}^{T}\end{matrix} ] .$$

By way of example, the bearing is therefore given by:

θᵢ(k)=[c_{i,1}(k)·θ_{i,1}(k)+c_{i,2}(k)·θ_{i,2}(k)+ . . . +c_{i,n}_{_{i,hyp}}₍ₖ₎(k)·θ_{i,n}_{_{i,hyp}}₍ₖ₎(k)]/cᵢ(k)

The initialization of this multi-hypothesis tracking method will be explained first of all. A total of m(1) tracks which each have only one hypothesis are generated from the measurement data zᵢ(1), i=1, . . . , m(1) in the detection list in the first clock cycle k=1. For this purpose, each measurement is converted to a hypothesis state vector

x_{i,1}(1)=H^{T}·zᵢ(k)i=1, . . . , m(1)

with the weight c_{i,1}(1)=1, and the corresponding state of the tracks is formed. H^{T} in this case denotes the transposed measurement matrix. An initial covariance matrix Pᵢ(1)=P⁰ is provided for all the tracks and:

SAᵢ(1)=0,ZÄᵢ(1)=0 and INᵢ(1)=0 for i=1, . . . , m(1).

The procedure for an undefined clock cycle from a clock cycle k≧1 to the clock cycle k+1 is characterized by the following steps:

As the initial situation, in the k-th clock cycle, there are n_{B}(k) confirmed and n_{T}(k) provisional target traces i. These have the state vector xᵢ(k), covariance Pᵢ(k) and the overall probability cᵢ(k), comprising the n_{i,hyp}(k) hypotheses j with a state vector x_{i,j}(k), covariance P_{i,j}(k) and hypothesis weight c_{i,j}(k). These are complemented by the status indicator SAᵢ(k) and the counter ZÄᵢ(k).

The target traces are predicted as follows: a prediction for the k+1-th clock cycle is calculated for each hypothesis j of a track i, on the basis of the dynamics of the process model and/or the target motion model dynamics. The predicted state is given by

x_{i,j}^{pre}(k+1)=F·x_{i,j}(k)

and the associated covariance by

P_{i,j}^{pre}(k+1)=F·P_{i j}(k)·F^{T}+Qᵢ(k),

where F is the transfer matrix and Qᵢ(k) is the process covariance matrix of the chosen process model.

New measurement data is associated as follows: the m(k+1) measurement data z_{I}(k+1) obtained for the k+1-th clock cycle is compared with the predicted hypotheses j of all the tracks i. If the I-th measurement is sufficiently close to the predicted measurement for the hypothesis j of the i-th track, that is to say the relationship

y_{i,j,I}^{T}(k+1)·S_{i,j,I}⁻¹(k+1)·y_{i,j,I}(k+1)<λ²

is true with suitable λ and the variables:

y_{i,k,I}(k+1)=z_{I}(k+1)−H·x_{i,j}^{pre}(k+1)

S_{i,j,I}(k+1)=H·P_{i,j}^{pre}(k+1)·H^{T}+R_{I}(k+1)

where R is the measurement error covariance matrix, then this measurement is associated with the hypothesis.

Target traces are then corrected as follows: a total of n_{i,j}(k+1)+1 new hypotheses are formed using the n_{i,j}(k+1) associated measurements α_{i,j} from each hypothesis j of the target trace i. In this case, the index α_{i,j}=0 represents the so-called failure hypothesis. This means that there is no measurement as a continuation of the initial hypothesis j for the target trace i. In addition, the indices α_{i,j}≧0 (for a hypothesis of a subset from the set of the indication from the measurements {1, 2, . . . , m(k+1)}) represent the link between the corresponding associated measurements. Overall, new hypotheses for which:

$${n}_{i , hyp}^{pre} ( k + 1 ) = {n}_{i , hyp} ( k ) + {\sum }_{j = 1}^{{n}_{i , hyp} ( k )} {n}_{i , j} ( k + 1 )$$

are produced from all the hypotheses j which exist in the clock cycle k for the i-th target trace n_{i,hyp}^{pre}(k+1).

The state vectors, covariances and weights for these new hypotheses h are calculated using the equations:

$${x}_{i , h} ( k + 1 ) = \{ \begin{matrix}{x}_{i , j}^{pre} ( k + 1 ) - {K}_{i , j , {α}_{i , j}} ( k + 1 ) \cdot {y}_{i , j , {α}_{i , j}} ( k + 1 ) & for {α}_{i , j} > 0 , \\ {y}_{i , j}^{pre} ( k + 1 ) & for {α}_{i , j} = 0\end{matrix}$$

for the state vectors,

$${P}_{i , h} ( k + 1 ) = \{ \begin{matrix}{P}_{i , j}^{pre} ( k + 1 ) - {K}_{i , j , {α}_{i , j}} ( k + 1 ) \cdot {S}_{i , j , {α}_{i , j}} ( k + 1 ) \cdot {K}_{i , j , {α}_{i , j}}^{T} ( k + 1 ) & for {α}_{i , j} > 0 , \\ {P}_{i , j}^{pre} ( k + 1 ) & for {α}_{i , j} = 0\end{matrix}$$

for the covariances and

$${c}_{i , h} ( k + 1 ) = \{ \begin{matrix}\frac{{c}_{i , j} ( k )}{{c}_{j} ( k )} \cdot \frac{{P}_{D}^{i , j} ( k + 1 )}{{ρ}_{F}} \cdot \frac{{e}^{- \frac{1}{2} {y}_{i , j , {α}_{i , j}}^{T} ( k + 1 ) {s}_{i , j , {α}_{i , j}}^{- 1} ( k + 1 ) {y}_{i , j , {α}_{i , j}} ( k + 1 )}}{\sqrt{det ( 2 π \cdot {S}_{i , j , {α}_{i , j}} ( k + 1 ) )}} & for {α}_{ij} > 0 , \\ \frac{{c}_{i , j} ( k )}{{c}_{j} ( k )} \cdot ( 1 - {P}_{D}^{i , j} ( k + 1 ) ) & for {α}_{ij} = 0\end{matrix}$$

for the weights. The variable K_{i,j,αi,j}(k+1) in the above equations is given by:

K_{i,j,αi,j}(k+1)=P_{i,j}^{pre}(k+1)·H^{T}·S_{i,j,αi,j}(k+1).

The term det( . . . ) denotes the determinant of a matrix, ρ_{F} is a constant which can be chosen as appropriate, and P_{D}^{i,j}(k+1) is a detection probability which can be calculated for each predicted hypothesis j of the track i using the equation:

$${P}_{D}^{i , j} ( k + 1 ) = \frac{{P}_{D}^{max}}{2} erfc ( \frac{{D}_{thr} - {a}_{i , j}^{pre} ( k + 1 )}{{σ}_{{a}_{i , j}}^{pre} ( k + 1 ) \cdot \sqrt{2}} ) .$$

In the last-mentioned equation, erfc( . . . ) means the complementary Gaussian error function, P_{D}^{max} and Dₜₕᵣ are constants which can be chosen appropriately, a_{i,j}^{pre}(k+1) is the predicted amplitude of the hypothesis j of the track i, and σₐ_{_{i,j}}^{pre}(k+1) is the associated estimation error.

Improbable hypotheses are deleted as follows: if the weight of a newly produced hypothesis h′, as described above, falls below a critical value, that is to say

c_{i,h′}(k+1)<c_{crit}

then the hypothesis is deleted from the hypothesis list for the target trace i. The number n_{i,hyp}^{pre}(k+1) of new hypotheses is reduced by the number of hypotheses found which satisfy the condition from the last-mentioned equation.

Resolution conflicts are dealt with as follows: in the case of broadband signal processing, all tracks i for which SAᵢ(k)=1 and INᵢ(k)=j≠0 are searched for from the track list. This means that these confirmed tracks have a resolution conflict with the corresponding confirmed tracks j. The resolution conflict consists in that the leading hypotheses for the tracks i and j have processed the same measurement z_{g}(k) in the data association for the clock cycle k−1 to k. The leading hypotheses are the hypotheses iₕ and jₕ of the tracks i and j which applies for c_{i,i}_{ₕ}(k)≧c_{i,α}(k) for all α≠iₕ and c_{j,j}_{ₕ}(k)≧c_{j,β}(k) for all β≠jₕ. If the resolution conflict still remains in this clock cycle, that is to say the leading hypotheses for the tracks i and j are once again associated with one and the same measurement z_{f}(k+1) of the current measurement data, a modified correction of the relevant target traces is carried out.

The resolution conflict for the track pair i and j is ended when a separation, which will be explained further below, between a hypothesis comprising at least one of the two tracks and the leading hypothesis ωₕ of a track ω which has already been confirmed in the last track is less than a critical value d_{Res}². The track ω must not be older than the relevant resolution conflict. If this is true for the hypothesis iₐ of the track i, the track ω is linked to the history of the track i, the track ω is removed from the track list, and the number of confirmed tracks is reduced by one. If this applies to a hypothesis jₐ of the track j, the track ω is linked to the history of the track j, the track ω is removed from the hypothesis list, and the number of confirmed tracks is reduced by one.

If a hypothesis which is sufficiently close to the leading hypothesis ωₕ of the track ω is found both for the track i and for the track j, the bearing rate \dot{Θ}_{i,i}_{ₕ}(k_{Res}^{i,j}−1) and \dot{Θ}_{j,j}_{ₕ}(k_{Res}^{i,j}−1), respectively, of both hypotheses from before the start of the resolution conflict at the time k_{Res}^{i,j} is compared with the bearing rate \dot{Θ}_{ω,ω}_{ₕ}(k+1) of the most recently found hypothesis ωₕ for the track ω. If the mathematical sign of the previous bearing rate of only one of the two hypotheses matches the current sign of the hypotheses ωₕ, the track ω is linked to the history of the relevant track, the track ω is removed from the track list, and the number of confirmed tracks is reduced by one. If the mathematical signs of the bearing rates of both tracks that are involved in the resolution conflict, from before the resolution conflict, match that of the hypothesis ωₕ of the track ω, the amplitudes from before the resolution conflict are compared with one another. If:

|a_{ω,ω}_{ₕ}(k+1)−a_{i,i}_{ₕ}(k_{Res}^{i,j}−1)|<|a_{ω,ω}_{ₕ}(k+1)−a_{j,j}_{ₐ}(k_{Res}^{i,j}−1)|

the track ω is linked to the history of the track i, the track ω is removed from the hypothesis list, and the number of confirmed tracks is reduced by one. If:

|a_{ω,ω}_{ₕ}(k+1)−a_{j,j}_{ₕ}(k_{Res}^{i,j}−1)|<|a_{ω,ω}_{ₕ}(k+1)−a_{i,i}_{ₕ}(k_{Res}^{i,j}−1)|

the track ω is linked to the history of the track j, the track ω is removed from the hypothesis list, and the number of confirmed tracks is reduced by one.

For the improbable situation in which the two differences are equal, the amplitude of the hypotheses for the tracks i and j can be taken from the time k_{Res}^{i,j}−2. A further possibility is to average the amplitudes in a window [k_{Res}^{i,j}−n_{average},k_{Res}^{i,j}−1].

If the resolution conflict for tracks i and j has not yet ended, the target traces are corrected as follows: as long as no conflict action has been initiated, there are nₖ+1 interpretation options for a (confirmed) target and nₖ measurements in the k-th clock cycle: (1) the target has not been detected. In consequence, all nₖ measurements are false (1 hypothesis) or (2) the target has been detected and the measurement j originates from the target, while the other nₖ−1 measurements are false (nₖ hypotheses). In the case of conflict action, further meaning options exist for the measurement data: (1) two objects are unresolved but are detected as a group; one of the nₖ measurements is treated as a measurement of the group centroid, while all the other measurements are false (nₖ hypotheses). (2) Two objects are neither resolved nor detected; all the measurements are false (1 hypothesis). (3) Two objects are resolved and are detected individually; nₖ−2 measurements are false (nₖ(nₖ−1) hypotheses). (4) Two objects are admittedly resolved, but only one has been detected; nₖ−1 measurements are false (2nₖ hypotheses). (5) Two hypotheses can admittedly be resolved, but neither has been detected; all measurements are false (1 hypothesis).

The probability of obtaining an unresolved measurement of two targets is a function of the resolution capability of the sensor used and of the separation, that is to say at the regulation separation between the targets. In this sense, the occurrence of an unresolved measurement can be interpreted as an additional separation measurement with the result “zero” and can be processed by the tracking algorithm. Since, in this situation, the measurement to be processed can no longer be related according to (4) to the state vector of a single target, but depends on the state vectors of two targets, it is necessary to introduce the centroid of and the separation between two targets as new state variables and to relate these to the variables bearing and amplitude a. This results in the unresolved state vector:

$${y}^{u} ( k ) = [ \begin{matrix}{θ}_{i} ( k ) - {θ}_{j} ( k ) \\ {θ}_{i} ( k ) + \frac{1}{2} ( {θ}_{j} ( k ) - {θ}_{i} ( k ) ) \\ \frac{1}{2} ( {a}_{i} ( k ) - {a}_{j} ( k ) )\end{matrix} ] .$$

The predicted unresolved measurements and the associated covariances are calculated by means of unscented transformation from the predicted hypotheses of the targets involved in the conflict. Since the resolution conflict is dealt with in the program process only after the normal Kalman update of the individual target state hypotheses, the individual target hypotheses are reweighted and modified taking account of the additional interpretation options for the measurement data. The common state hypotheses for the targets involved in the conflict are formed from the individual target hypotheses. By way of example, if it has been possible to associate n₁ measurements with a first target in the current time step and n₂ measurements with a second target, n₁×n₂ hypotheses must be considered for the combined target state. In order to reduce the complexity of the algorithm, the common target hypotheses are converted back to individual target hypotheses immediately after the update, as a result of which the number of individual target hypotheses under consideration remains constant. The individual target state is in this case calculated as the sum of the common target hypotheses in question, and approximates the probability density:

p(x₁)=∫p(x₁,x₂)d×x₂

via so-called second order moment matching. It is therefore necessary to calculate the common probability density p(x₁(k+1), x₂(k+1)|Z^{k+1}) on the basis of all the measurements Z^{k+1}={Zₖ₊₁,Z^{k}} up to the current time in order to update the individual target hypotheses. On the assumption that the target states are independent of previous times, the density can be calculated using:

p(x₁(k+1),x₂(k+1)|Z^{k+1})=p(Zₖ₊₁|x₁(k+1),x₂(k+1))p(x₁(k+1)|Z^{k})p(x₂(k+1)|Z^{k}).

The common hypothesis weights are calculated corresponding to the various data interpretations (1) to (5) and using the following scheme:

p(x₁(k+1),x₂(k+1)|Z^{k+1})=pᵢp(x₁(k)|Z^{k})p(x₂(k)|Z^{k}),i=1, . . . , 5

where pᵢ depends on the data interpretation (1) to (5).

The common target state is in each case updated using the Kalman update formulae for every possible combination of individual target hypotheses. P_{D}^{u} denotes the detection probability for the unresolved target state, P_{D}ⁱ is the detection probability for the i-th target state, and Pᵤ is the probability of two targets not being resolved.
(1) The common target state is calculated via an update with the unresolved measurement zᵢ(k+1) and the fictional measurement “Separation=0”. The reweighting process is carried out using:

p₁=PᵤP_{D}^{u}/f_{c}p(zᵢ(k+1)|x₁(k+1),x₂(k+1),‘Measurement unresolved’)
(2) Only the fictional measurement is used to update the common target state. The reweighting is carried out using:

p₂=Pᵤ(1−P_{D}^{u}).
(3) The common target state is determined by means of an update with the two resolved measurements zᵢ(k+1) and zⱼ(k+1):

p₃=(1−Pᵤ)P_{D}¹P_{D}²/f_{c}²p(zᵢ(k+1),zⱼ(k+1)|x₁(k+1),x₂(k+1),‘Measurement resolved’)
(4) Without any restriction to generality, the first target is assumed to be detected via the measurement zᵢ(k+1), in which case the common target state results from the combination of the target state updated with the measurement zᵢ(k+1) for target 1, and the predicted target state for target 2:

p₄=(1−Pᵤ)(1−P_{D}²)P_{D}¹/f_{c}p(zᵢ(k+1)x₁(k+1),‘Measurement resolved’)
(5) The common target state comprises the two predicted individual target states:

p₅=(1−Pᵤ)1−P_{D}¹)(1−P_{D}²).

The splitting of target traces will be explained in the following text. A check is carried out for each track to determine whether the hypotheses h₁ and h₂ with the highest weight have an excessive separation d_{i,h}_{₁}_{,h}_{₂}, calculated using the formula:

d_{i,h}_{₁}_{,h}_{₂}²=(x_{i,h}_{₁}(k+1)−x_{i,h}_{₂}(k+1))^{T}(P_{i,h}_{₁}(k+1)+P_{i,h}_{₂}(k+1))⁻¹(x_{i,h}_{₁}(k+1)−x_{i,h}_{₂}(k+1))

If the relationship:

d_{i,h}_{₁}_{,h}_{₂}²>dₛₚₗᵢₜ²

is satisfied with a suitably chosen dₛₚₗᵢₜ, one of the two hypotheses is split off as a new track i′ with only one hypothesis in the clock cycle k+1. This split-off track has the history attached to it up to track k from track i. Depending on the status of the initial track i, the number of confirmed or provisional tracks is increased by one.

The fusion of target traces will be explained in the following text: the tracks that are present are compared with one another in pairs. The separation d_{i1,i2} between two tracks i₁ and i₂ is given by:

dᵢ_{₁},i_{₂}=(xᵢ_{₁}(k+1)−xᵢ_{₂}(k+1))^{T}(Pᵢ_{₁}(k+1)+Pᵢ_{₂}(k+1))⁻¹(xᵢ_{₁}(k+1)−xᵢ_{₂}(k+1)).

If the covariances are not excessive and SAᵢ₁(k+1)≠SAᵢ₂(k+1), that is to say only one of the two tracks has already been confirmed, and, furthermore:

dᵢ_{₁},i_{₂}²<d_{merge}²

with a suitably chosen d_{merge}, then the more recent of the two tracks is deleted. Depending on whether this is a confirmed track or a provisional track, the corresponding number n_{B}(k) or n_{T}(k) is reduced by one.

The fusion of hypotheses will be explained in the following text: the hypotheses of a track i are compared with one another in pairs. If the separation between two hypotheses H₁ and H₂ satisfies the condition:

d_{i,h}_{₁}_{,h}_{₂}<d_{merge,hyp}²

with suitably chosen d_{merge,hyp}, then the two hypotheses are combined using the formulae:

$$\begin{matrix}{x}_{i , {h}_{12}} ( k + 1 ) = {\sum }_{r = 1 , 2} {c}_{i , {h}_{r}} ( k + 1 ) {x}_{i , {h}_{r}} ( k + 1 ) \\ {P}_{i , {h}_{12}} ( k + 1 ) = {\sum }_{r = 1 , 2} {c}_{i , {h}_{r}} ( k + 1 ) \times \\ [ \begin{matrix}{P}_{i , {h}_{r}} ( k + 1 ) + ( {x}_{i , {h}_{r}} ( k + 1 ) - {x}_{i , {h}_{12}} ( k + 1 ) ) \\ {( {x}_{i , {h}_{r}} ( k + 1 ) - {x}_{i , {h}_{12}} ( k + 1 ) )}^{T}\end{matrix} ] \\ {c}_{i , {h}_{12}} ( k + 1 ) = {\sum }_{r = 1 , 2} {c}_{i , {h}_{r}} ( k + 1 )\end{matrix}$$

to form one new hypothesis. The number of hypotheses for the track i is reduced by the number of hypothesis pairs found which satisfy the condition d_{i,h}_{₁}_{,h}_{₂}d_{merge,hyp}².

The formation of new provisional target traces will be explained in the following text: new provisional target traces τ are formed from all the n_{T}^{new}(k+1) measurements z_{I}(k+1) which are not associated with any predicted hypothesis. As in the initialization phase, each target trace newly created in this way is formed from a hypothesis with the abovementioned hypothesis state vector x_{i,1}(1)=H^{T}+Zᵢ (k), a covariance P_{τ1}(k+1)=P⁰, the weight c_{τ,1}(k+1)=1 and the values SA_{τ}(k+1)=0, ZÄ_{τ}(k+1)=0 and IN_{τ}(k+1)=0. The number of provisional target traces is increased by this number of unassociated measurements.

The calculation of the likelihood quotient LR will be explained in the following text. The probability quotient LRᵢ(k+1) for the clock cycle k+1 can be calculated for each track i from the weights c_{i,h}(k+1) of all the hypotheses h associated with this track, using the equation:

$${LR}_{i} ( k + 1 ) = {\sum }_{h} {c}_{i , h} ( k + 1 )$$

and is thus formally identical to the overall probability cᵢ(k+1) of the i-th target trace.

The testing of the tracks that are present will be explained in the following text: the sequential probability quotient test is carried out for each track i. For this purpose, the value of LRⱼ(k+1) is compared with two bounds A and B. If the track i is a confirmed track, the counter of track i is increased by one if the bound B is exceeded, that is to say ZÄᵢ(k+1)=ZÄᵢ(k)+1, and if the bound A is undershot, it is reduced by one, that is to say ZÄᵢ(k+1)=ZÄᵢ(k)−1. If the value of LRᵢ(k+1) is between the two values, the counter remains unchanged. If the track i is a provisional track, the counter is increased by one if the bound B is exceeded, that is to say ZÄᵢ(k+1)=ZÄᵢ(k)+1, and if the bound A is undershot, the counter is reduced by one, that is to say ZÄᵢ(k+1)=ZÄᵢ(k)−1, provided that ZÄᵢ(k)≠0. However, if ZÄᵢ(k)=0, then ZÄᵢ(k+1)=0. If LRᵢ(k+1) is between the two bounds, the counter also remains unchanged for provisional tracks. Both for confirmed tracks and for provisional tracks i, the weights of associated hypotheses are normalized if the bound B is overshot, that is to say each weight c_{i,h}(k+1) is divided by the sum of all the weights, using the expression:

$${c}_{i , h} ( k + 1 ) -> \frac{{c}_{i , h} ( k + 1 )}{{\sum }_{h = 1}^{{n}_{i , hyp} ( k + 1 )} {c}_{i , h} ( k + 1 )} .$$

The setting of the track status will be explained in the following text: the status indicator SAᵢ(k+1) is set to 1 for each track i for which ZÄᵢ(k+1)>ZÄ_{crit}, that is to say it is “confirmed”. If SAᵢ(k)=0 in the previous clock cycle, the number n_{B}(k) of confirmed tracks is increased by one. The status indicator SAᵢ(k+1) is set to 0 for tracks for which ZÄᵢ(k+1)<ZÄ_{crit}, that is to say it is set to “provisional”. If SAᵢ(k)=1 in the previous clock cycle, the number of confirmed tracks is reduced by one, and the number n_{T}(k) is increased by one. The value ZÄ_{crit} is a critical number, which can be chosen appropriately, of overshoots of the upper bound B.

The reassessment of previous states will be explained in the following text: since the knowledge about the track state is enhanced with the aid of each new measurement, the history of a track i can be recalculated and reassessed. Specifically, in this case, all the hypotheses h for a track i with SAᵢ(k+1)=1 are calculated back for a maximum of nᵣₑₜᵣₒ time steps into the past. If the track exists only for nₑₓᵢₛₜ<nᵣₑₜᵣₒ time steps, only this number of steps are carried out. The state vectors and covariances recalculated for the hypotheses for the clock cycles I,I=k,I−1, . . . , k+1−nᵣₑₜᵣₒ are obtained from the equations:

x_{i,h}^{retro}(I)=x_{i,h}(I)+W_{i,h}(I)·(x_{i,h}^{retro}(I+1)−x_{i,h}^{pre}(I+1))

P_{i,h}^{retro}(I)=P_{i,h}(I)·(P_{i,h}retro(I++1)−P_{i,h}^{pre}(I+1))·W_{i,h}^{T}(I)

and

W_{i,h}(I)=P_{i,h}(I)·F^{T}·P_{i,h}^{pre}^{^{−1}}(I+1)

where F is the transfer matrix of the process model. The retrospective hypothesis weight of the h-th hypothesis in the clock cycle I is obtained from the sum of the weights of all the retrospective hypotheses in the I+1-th clock cycle, which are formed from the hypothesis h in the normal multi-hypothesis cycle in the clock cycle I to I+1:

$${c}_{i , h}^{retro} = {\sum }_{ξ = 1}^{{n}_{i , hyp} ( l + 1 )} {c}_{i , ξ} ( l + 1 )$$

After the end of the clock cycle, an updated track list exists with n_{B}(k+1) confirmed tracks and n_{T}(k+1) provisional tracks i with a state vector xᵢ(k+1), covariance Pᵢ(k+1) and overall weight cᵢ(k+1), which are respectively formed from nᵢ(k+1) hypotheses j with state vectors x_{i,j}(k+1), covariances P_{i,j}(k+1) and hypothesis weights c_{i,h}(k+1). The updated status indicators SAᵢ(k+1) and counters ZÄᵢ(k+1) and INᵢ(k+1) also exist.

Track data in a read block 43 is read and is processed further from the tracking system described above. In this case, depending on the signal processing, a distinction is drawn between whether the track data is passed on to a corresponding output system 44 in the same way as in the case of broadband signal processing, or whether the track data will also pass through a further management block 45, as in the case of narrowband signal processing, before being passed on to the appropriate output system. For any given k-th clock cycle which is picked out, the following lists of the n(k)=n_{B}(k)+n_{T}(k) tracks are passed on as track data, to be precise for the case of broadband signal processing:

$$\begin{matrix}1 : & {θ}_{1} ( k ) , & {\dot{θ}}_{1} ( k ) , & {a}_{1} ( k ) , & {\dot{a}}_{1} ( k ) , & {σ}_{{θ}_{1}} ( k ) , & {σ}_{{\dot{θ}}_{1}} ( k ) , & {σ}_{{a}_{1}} ( k ) , & {σ}_{{\dot{a}}_{1}} ( k ) , & S {A}_{1} ( k ) \\ 2 : & {θ}_{2} ( k ) , & {\dot{θ}}_{2} ( k ) , & {a}_{2} ( k ) , & {\dot{a}}_{2} ( k ) , & {σ}_{{θ}_{2}} ( k ) , & {σ}_{{\dot{θ}}_{2}} ( k ) , & {σ}_{{a}_{2}} ( k ) , & {σ}_{{\dot{a}}_{2}} ( k ) , & S {A}_{2} ( k ) \\ & ⋮ & ⋮ & ⋮ & ⋮ & ⋮ & ⋮ & ⋮ & ⋮ & ⋮ \\ n ( k ) : & {θ}_{n} ( k ) , & {\dot{θ}}_{n} ( k ) , & {a}_{n} ( k ) , & {\dot{a}}_{n} ( k ) , & {σ}_{{θ}_{n}} ( k ) , & {σ}_{{\dot{θ}}_{n}} ( k ) , & {σ}_{{a}_{n}} ( k ) , & {σ}_{{\dot{a}}_{n}} ( k ) , & S {A}_{n} ( k )\end{matrix}$$

and for the case of narrowband signal processing:

$$\begin{matrix}1 : & as BDT plus , additionally & {v}_{1} ( k ) , & {\dot{v}}_{1} ( k ) , & {σ}_{{v}_{1}} ( k ) , & {σ}_{{\dot{v}}_{1}} ( k ) \\ 2 : & as BDT plus , additionally & {v}_{2} ( k ) , & {\dot{v}}_{2} ( k ) , & {σ}_{{v}_{2}} ( k ) , & {σ}_{{\dot{v}}_{2}} ( k ) \\ & ⋮ & ⋮ & ⋮ & ⋮ & ⋮ \\ n ( k ) : & as BDT plus , additionally & {v}_{n} ( k ) , & {\dot{v}}_{n} ( k ) , & {σ}_{{v}_{n}} ( k ) , & {σ}_{{\dot{v}}_{n}} ( k )\end{matrix}$$

The abovementioned management block 45 in the case of narrowband signal processing is used to combine the confirmed individual line tracks produced by the tracking system in the case of narrowband processing, that is to say tracks of individual frequency lines, referred to for short as SLT (single line tracks) to form multi-line tracks, or MLT for short. In this case, the SLTs which are combined with one another are those for which the bearing and the bearing rate match sufficiently well. The frequency lines which all originate from one direction are therefore combined. Furthermore, a check is carried out in this block for each existing MLT to determine whether the bearing or the bearing rate of one specific SLT differs excessively from the bearing or the bearing rate of the MLT, which is itself calculated from the averaging of the bearing and the bearing rate of all the SLTs combined in the MLT. If an SLT such as this is found, it is removed from the MLT, and is managed as a new MLT which comprises only one frequency line. All further SLTs which cannot be associated with existing MLTs and cannot be combined with one another are managed in the same way as MLTs with only one frequency line.

The output systems HMI-1 and HMI-2 are shown as the remaining blocks 44 and 46. In the case of broadband signal processing, those tracks whose status is confirmed in the relevant clock cycle k are selected first of all. From the target traces identified using the MHT method, that hypothesis j whose weight c_{i,j}(k) is the greatest is selected for each track i. The corresponding value of the bearing of this hypothesis θ_{i,j}(k) is then displayed in a so-called waterfall plot of the bearing angle plotted against time, by displaying the bearing of all detections over the course of time, color-coded on the basis of the strength of the respective amplitude.

In the case of narrowband signal processing, the bearing θ̅ⱼ(k) determined from all the SLTs associated with the MLT is taken for each MLT i (combined confirmed SLTs) in the k-th clock cycle, in which case, from each j-th SLT, the bearing θ_{j,I}(k) of the hypothesis I with the strongest weight c_{j,I}(k) is in each case included in the averaging process, and is displayed on a waterfall plot. In addition, the frequency ν_{j,I}(k) of the strongest hypothesis I of all SLTs j of each individual MLT i is taken, and is displayed on a waterfall plot.

FIG. 5 shows the data flow based on the multi-hypothesis tracking method in the block 42 annotated MHT in FIG. 4. In block 50, data is read from the sonar installation, to be precise preferably bearing angles and amplitudes, as well as a frequency in the case of narrowband signal processing. The data read in is then transferred to a data association block 51, which associates the data read in with predicted trace state vectors in block 52.

The associated data is then transferred from block 51 to block 53, which estimates the state vector on the basis of the measurement data and the associated predicted data for the predicted state vector. The block 53 is therefore also referred to as an estimation filter block, and also carries out the correction process on target traces.

A management block 54, which follows the estimation filter block 53, is used to carry out the described deletion of improbable hypotheses, the resolution conflict handling, the splitting of target traces, the fusion of target traces, the fusion of hypotheses, and the formation of new provisional target traces.

A likelihood quotient calculation block 55, which follows the management block 54, calculates the likelihood quotient LR, as described above.

The likelihood quotient calculation block 55 is followed by a test block 56 which carries out the testing of tracks, as described above. The setting of the track status, as described above, is carried out in a track status block 57, which follows this test block.

Previous states are reassessed, as stated above, in a reassessment block 58 which follows the track status block 57. An updated track list is then stored in the track list block 59, on the basis of the reassessment of the history. This track list is once again used by the prediction block 52 in order to carry out new predictions.

All the features mentioned in the above description of the figures, in the claims and in the introductory part of the description can be used both individually and in any desired combination with one another. The invention is therefore not restricted to the described and/or claimed feature combinations. In fact, all feature combinations can be considered as having been disclosed.

1. Direction-finding method for detection and tracking of successive bearing angles (Θ) of sound-emitting targets over the entire azimuth panorama or a predeterminable azimuth sector using a direction-finding antenna (1) having a multiplicity of electroacoustic or optoacoustic transducers (2.1, 2.2, 2.n) for receiving sound waves and producing received signals, wherein, in each clock cycle and separated by time intervals, received signals from in each case all or a group of the transducers are added cophase to form array signals after a propagation time delay and/or phase shift, as a function of their geometric arrangement with respect to a reference line (B), with each of which array signals a directional characteristic is associated with a main reception direction (I, II, III) which is associated with a bearing angle and is at right angles to the reference line (B), and intensities are indicated as an intensity plot, corresponding to the amplitude or the level of the array signals as a function of the bearing angle (Θ) in each clock cycle (T), wherein intensity plots of successive clock cycles (T) in a waterfall plot show bearing traces of successive bearing angles, and preferred bearing traces are marked by a tracker, characterized
in that, starting from trace state vectors (\hat{x}(k−1/k−1)), which are determined at the time t=k−1, are each associated with one bearing trace and each have a bearing angle (Θ) as well as its time derivative, which is referred to as the bearing rate (\dot{Θ}) and possibly an intensity (a) and its time derivative, which is referred to as the intensity rate (\dot{a}) and trace errors associated with the trace state vectors (\hat{x}(k−1/k−1)) for the time t=k, predicted trace state vectors (x^{pre}(k/k−1)), which each have a predicted bearing angle (Θ^{pre}) and its time derivative, which is referred to as the predicted bearing rate (\dot{Θ}), and possibly a predicted intensity (a^{pre}) and its time derivative, which is referred to as the predicted intensity rate (\dot{a}^{pre}), are predicted together with predicted estimation errors,
in that the prediction of each predicted trace state vector (x^{pre}(k/k−1)) and of its estimation error are used as the basis for the approximation of a time profile of a bearing trace with linear subelements as target motion model dynamics,
in that each predicted bearing angle (Θ^{pre}(k/k−1)) is calculated from the sum of the bearing angle (Θ(k−1)) determined most recently at the time t=k−1 and a most recently determined bearing rate (\dot{Θ}(k−1)), multiplied by the clock cycle (T), for the same bearing trace, and possibly each predicted intensity (a^{pre}(k/k−1)) is calculated from the sum of the intensity (a(k−1)) determined most recently at the time t=k−1 and a most recently determined intensity rate (\dot{a}(k−1)), multiplied by the clock cycle (T), of the same bearing trace,
in that an association probability is in each case determined for association of a measured bearing angle (Θ^{meas}(k)) and possibly a measured intensity (a^{meas}(k)) with one of the bearing traces,
in that, as a function of a determined association probability, a measured bearing angle (Θ^{meas}(k)) and possibly a measured intensity (a^{meas}(k)) are calculated, together with a predicted bearing angle (Θ^{pre}(k/k−1)) and possibly a predicted intensity (a^{pre}(k/k−1)), to form an estimated bearing angle (\hat{Θ}(k)) and possibly an estimated intensity (â(k)) at the time t=k, and
the estimated value or values determined in this way, together with the estimated bearing rate and possibly estimated intensity rate, form the trace state vector (\hat{x}((k/k)) of the relevant bearing trace and, when a plurality of measured bearing angles and possibly a plurality of measured intensities are associated to form a bearing trace, the respective estimated values are added in a weighted form, forming the trace state vector (\hat{x}(k/k)) of this bearing trace, and this trace state vector (\hat{x}(k/k)) provides the output variables of the trace state vector, predicted in the next clock cycle (T), for the relevant bearing trace for prediction from t=k to t=k+1, and
in that bearing traces formed in this way are indicated as a function of a trace quality.

2. Direction-finding method according to claim 1, characterized in that a trace quality (L), which is added over a predeterminable number of clock cycles, is calculated from the association probability, presetting a detection probability (P_{D}) and false alarm probability (P_{FA}) for a bearing angle and possibly an intensity with an angle interval (ΔΘ) between two adjacent direction characteristics, which trace quality (L) is compared with bounds (T₁) and (T₂) for initiation of a new bearing trace or for deletion of a bearing trace, wherein the bounds
$$( {T}_{1} = ln ( \frac{β}{1 - α} ) , {T}_{2} = ln ( \frac{1 - β}{α} ) )$$
are predetermined by predetermined probabilities (α, β) for the confirmation of a false bearing trace or the deletion of a true bearing trace, and in that the start of confirmed bearing traces indicates the detection of a target, and these bearing traces are indicated for target tracking.

3. Direction-finding method according to claim 1, characterized in that the association probability of a measured bearing angle Θ^{mess}(k) and possibly a measured intensity a^{mess}(k) are determined to form one of the bearing traces as a function of the bearing angle Θ^{pre}(k/k−1) predicted from k−1 to k, and possibly the intensity a^{pre}(k/k−1) predicted from k−1 to k, by a squared, normalized statistical interval
$${d}_{θ}^{2} = \frac{{( {Θ}^{pre} ( k / k - 1 ) - {Θ}^{meas} ( k ) )}^{2}}{{σ}_{Θ}^{2 meas} + {σ}_{\hat{Θ}}^{2} ( k / k - 1 )} and$$
$${d}_{a}^{2} = \frac{{( {a}^{pre} ( k / k - 1 ) - {a}^{meas} ( k ) )}^{2}}{{σ}_{a}^{2 meas} + {σ}_{\hat{a}}^{2} ( k / k - 1 )}$$
wherein the squared bearing angle difference (Θ^{pre}(k/k−1)−Θ^{meas}(k))² or squared intensity difference (a^{pre}(k/k−1)−a^{meas}(k))² is related to the sum of the squared measurement error σ_{Θ}^{2meas} and σ_{α}^{2meas} and the squared predicted estimation error σ_{\hat{Θ}}²(k/k−1) and σ_{â}²(k/k−1) of the bearing angle and intensity, respectively, and the association probability is a maximum when the squared, normalized statistical interval d_{θ}² or dₐ² is a minimum.

4. Direction-finding method according to claim 1, characterized in that the trace quality L(k) of each bearing trace is determined on the basis of the trace quality L(k−1) of the previous clock cycle and a quality increment ΔL to be:
L(k)=L(k−1)+ΔL,
wherein the quality increment ΔL of a detection probability P_{D} for a real bearing angle in the angle interval ΔΘ of the main reception direction of two directional characteristics is determined from a predeterminable density β_{NT} of newly detected bearing angles Θ in each time interval in the azimuth panorama or azimuth sector, the angle interval Δη, a false alarm probability P_{FA} from a predeterminable density β_{FT} of false alarms in the azimuth panorama or azimuth sector, and a square root of an error sum S from the squared measurement error (σ_{Θ}^{2meas} and σₐ^{2meas}) and the squared trace error (σ_{\hat{Θ}}²(k/k) and σ_{â}²(k/k)) and the squared, normalized statistical interval (d²(k/k−1)) to be:
$$Δ L = ln \frac{{P}_{D} \cdot ΔΘ}{{P}_{FA} \sqrt{\vert S \vert}} - \frac{{d}^{2} ( k / k - 1 ) + M \cdot ln 2 π}{2} ,$$
where M denotes a measurement vector dimensionality where M=1, 2, 3, . . . and the quality increment (ΔL) is recalculated for each clock cycle and is added over all or a predeterminable number of clock cycles to form the most recently determined trace quality (L(k−1)).

5. Direction-finding method according to claim 1, characterized in that the array signals are processed in a narrowband form, an intensity is measured and a frequency is determined for each measured bearing angle, and each measurement vector therefore has a measured bearing angle, a measured intensity and a measured frequency, and each estimated trace state vector in each case has an estimated bearing angle, an estimated bearing rate, an estimated intensity, an estimated intensity rate, an estimated frequency and an estimated frequency rate.

6. Direction-finding method according to claim 3, characterized in that the direction-finding antenna comprises a linear antenna, wherein the measurement error σ_{θ}_{^{meas}} of the bearing angle is a function of the currently measured bearing angle θⱼ^{meas}(k) and the currently measured intensity aⱼ^{meas}(k), the own course θ₀(k) of a watercraft which is fitted with or is towing the direction-finding antenna and a constant σ_{θ}⁰, as follows:
$${σ}_{{θ}^{meas}} = \frac{{σ}_{θ}^{0}}{\vert sin ( {θ}_{j}^{meas} ( k ) - {θ}_{0} ( k ) ) \vert \cdot \sqrt{{a}_{j}^{meas} ( k )}}$$
where the index j denotes a measurement obtained at the time t=k of a total of m(k) measurements, where j=1, . . . , m(k).

7. Direction-finding method according to claim 1, characterized in that, when a plurality of measured bearing angles and possibly measured intensities are associated to form a bearing trace, a state vector xᵢ(k), a covariance matrix Pᵢ(k) for indication of an estimation error and an overall probability cᵢ(k) are associated with a bearing trace i at a time t=k, wherein the state vector xᵢ(k) is approximated from a weighted sum of a plurality of individual state vectors which are determined from a plurality n_{i,hyp}(k) of interpretation hypotheses for association of measured bearing angles and possibly measured intensities and possibly measured frequencies with an already existing target trace, wherein c_{i,j}(k), j=1, . . . , n_{i,hyp}(k) indicates the weights of the hypotheses, to be precise as follows:
$${x}_{i} ( k ) = \frac{1}{{c}_{i} ( k )} {\sum }_{j = 1}^{{n}_{i , hyp} ( k )} {c}_{i , j} ( k ) {x}_{i , j} ( k ) ,$$
where the overall probability cᵢ(k) is determined to be:
$${c}_{i} ( k ) = {\sum }_{j = 1}^{{n}_{i , hyp} ( k )} {c}_{i , j} ( k )$$
and the covariance matrix Pᵢ(k) is determined to be:
$${P}_{i} ( k ) = \frac{1}{{c}_{i} ( k )} {\sum }_{j = 1}^{{n}_{i , hyp} ( k )} {c}_{i , j} ( k ) [ \begin{matrix}{P}_{i , j} ( k ) + ( {x}_{i , j} ( k ) - {x}_{i} ( k ) ) \\ \cdot {( {x}_{i , j} ( k ) - {x}_{i} ( k ) )}^{T}\end{matrix} ] .$$

8. Direction-finding method according to claim 7, characterized in that the possible bearing traces are stored continuously in a bearing trace list, which bearing trace list has, for a bearing trace i at the time t=k, a state vector xᵢ(k), a covariance matrix Pᵢ(k), an overall probability cᵢ(k) and a status indicator SAᵢ(k) in order to indicate whether the bearing trace is confirmed or is provisional, and a counter ZÄᵢ(k), which is incremented or decremented as a function of the existence or non-existence of a sequential likelihood quotient test at the time t=k, and an indicator INᵢ(k) which indicates the bearing trace for which there is a possible resolution conflict with a confirmed bearing trace.

9. Direction-finding method according to claim 7, characterized in that each bearing trace is investigated for the existence of a possible resolution conflict, which occurs when the two bearing traces of associated targets appear at essentially the same bearing angle,
wherein the existence of a resolution conflict is identified when the leading hypotheses, on the basis of the weight, of two bearing traces process the same measurement,
a resolution conflict is identified as having ended when a separation between a hypothesis from at least one of the two bearing traces and the leading hypothesis of a bearing trace confirmed in the last clock cycle is less than a predetermined value.

10. Direction-finding method according to claim 9, characterized in that, if the confirmed bearing trace is no older than the resolution conflict, the confirmed bearing trace is linked to the history of that bearing trace which is associated with that hypothesis whose separation from the leading hypothesis is less than the predetermined value, wherein the confirmed bearing trace is rejected, or is removed from a bearing trace list, and the number of confirmed bearing traces is reduced by one.

11. Direction-finding method according to claim 9, characterized in that if, for both of the bearing traces which are subject to a resolution conflict, a hypothesis exists whose separation from the leading hypothesis is less than a predetermined value, the bearing rate of both hypotheses from before the start of the resolution conflict is compared with the bearing rate of the currently found hypothesis of the confirmed track, and
if there is a match between the mathematical sign of the bearing rate from before the start of the resolution conflict of only one of the two hypotheses with the mathematical sign of the current hypothesis of the confirmed bearing trace, the confirmed bearing trace is linked to the history of the relevant bearing trace, the confirmed bearing trace is rejected, or is removed from the bearing trace list, and the number of confirmed bearing traces is reduced by one, and
if there is a match between the mathematical signs of the bearing rate from before the start of the resolution conflict of the two hypotheses with the mathematical sign of the current hypothesis of the confirmed bearing trace, the intensities of the bearing traces are compared, and
if the magnitude of the difference between the current intensity of the confirmed bearing trace and the intensity of one of the two bearing traces involved in the resolution conflict from before the start of the resolution conflict is less than the magnitude of the difference between the current intensity of the confirmed bearing trace and the intensity of the other of the two bearing traces involved in the resolution conflict from before the start of the resolution conflict,
the confirmed bearing trace is linked to the history of the relevant bearing trace, the confirmed bearing trace is rejected, or is removed from the bearing trace list, and the number of confirmed bearing traces is reduced by one.

12. Direction-finding method according to claim 5, characterized in that bearing traces of individual frequency lines are produced, wherein confirmed bearing traces of individual frequency lines are combined to form so-called multi-line bearing traces of a plurality of frequency lines for which the bearing and bearing rate match within a predetermined limit.

13. Direction-finding method according to claim 12, characterized in that multi-line bearing traces are checked to determine whether the bearing or bearing rate of a specific bearing trace of an individual frequency line differs by more than a respective predetermined limit value from the bearing or the bearing rate of the respective multi-line bearing trace which has been calculated from the averaging of the bearing or bearing rate of all the bearing traces of individual frequency lines combined in this multi-line bearing trace and, if such a bearing trace of an individual frequency line is found, this is removed from the relevant multi-line bearing trace and is managed as a new multi-line bearing trace which, however, comprises only one frequency line, and all the further bearing traces of individual frequency lines which cannot be associated with existing multi-line bearing traces and cannot be combined with one another are managed in the same way as multi-line bearing traces with only one frequency line.

14. Direction-finding installation for detection and tracking of successive bearing angles (Θ) of sound-emitting targets over the entire azimuth panorama or a predeterminable azimuth sector, in particular for carrying out a direction-finding method according to claim 1, having a direction-finding antenna (1) with a multiplicity of electroacoustic or optoacoustic transducers (2.1, 2.2, 2.n) for receiving sound waves and producing received signals, and having a beamformer, which is designed such that, in each clock cycle and separated by time intervals, it adds received signals of in each case all or a group of the transducers cophase to form array signals after a propagation time delay and/or phase shift as a function of their geometric arrangement with respect to a reference line (B), with each of which array signals a directional characteristic is associated with a main reception direction (I, II, III) which is associated with a bearing angle and is at right angles to the reference line (B), and having display means (4), which are designed to display intensities corresponding to the amplitude or the level of the array signals as a function of the bearing angle (Θ) in each clock cycle (T) as an intensity plot, wherein intensity plots of successive clock cycles (T) in a waterfall plot show bearing traces of successive bearing angles, and preferred bearing traces can be marked by a tracker,
characterized
in that the direction-finding installation has a Kalman filter (5) in which starting from trace state vectors (\hat{x}(k−1/k−1)), which are determined at the time t=k−1, are each associated with one bearing trace and each have a bearing angle (Θ) as well as its time derivative, which is referred to as the bearing rate (\dot{Θ}) and possibly an intensity (a) and its time derivative, which is referred to as the intensity rate (â), and trace errors (\hat{P}(k−1/k−1)), which are associated with the trace state vectors (\hat{x}(k−1/k−1)), trace state vectors (x^{pre}(k/k−1)), which are predicted for each bearing trace for the time t=k and each have a predicted bearing angle (Θ^{pre}) and its time derivative, which is referred to as the predicted bearing rate (\dot{Θ}^{pre}), and possibly a predicted intensity (a^{pre}), and its time derivative which is referred to as the predicted intensity rate (â^{pre}) can be predicted together with predicted estimation errors in a prediction stage (5.1), wherein the prediction of each predicted trace state vector (x^{pre}(k/k−1)) and its estimation error are used as the basis for the approximation of a time profile of a bearing trace with linear subelements as target motion model dynamics,
wherein each predicted bearing angle (Θ^{pre}(k/k−1)) can be calculated from the sum of the bearing angle (Θ(k−1)) determined most recently at the time t=k−1 and a most recently determined bearing rate (\hat{Θ}(k−1)), multiplied by the clock cycle (T), for the same bearing trace, and possibly each predicted intensity (a^{pre}(k/k−1)) can be calculated from the sum of the intensity (a(k−1)) determined most recently at the time t=k−1 and a most recently determined intensity rate (\dot{a}(k−1)), multiplied by the clock cycle (T), of the same bearing trace,
in that the direction-finding installation has a measurement data association stage (8) which is designed such that it in each case determines an association probability of association of a measured bearing angle (Θ^{meas}(k)) and possibly a measured intensity (a^{meas}(k)) for one of the bearing traces, wherein as a function of a determined association probability, a measured bearing angle (Θ^{meas}(k)) and possibly a measured intensity (a^{meas}(k)) are calculated, together with a predicted bearing angle (Θ^{pre}(k/k−1)) and possibly a predicted intensity (a^{pre}(k/k−1)), to form an estimated bearing angle (\hat{Θ}(k)) and possibly an estimated intensity (â(k)) at the time t=k, and the estimated value or values determined in this way, together with the estimated bearing rate and possibly estimated intensity rate, form the trace state vector (\hat{x}(k/k)) of the relevant bearing trace or, when a plurality of measured bearing angles and possibly a plurality of measured intensities are associated to form a bearing trace, the respective estimated values are added in a weighted form, forming the trace state vector (\hat{x}(k/k)) of this bearing trace, and this trace state vector (\hat{x}(k/k)) provides the output variables of the trace state vector, predicted in the next clock cycle (T), for the relevant bearing trace for prediction from t=k to t=k+1, and in that the display means (13, 14, 4) are designed such that bearing traces formed in this way can be displayed as a function of a trace quality.

15. Direction-finding installation according to claim 14, characterized in that, in order to predict the predicted state vector
$${x}^{pre} ( k / k - 1 ) = [ \begin{matrix}{Θ}^{pre} ( k / k - 1 ) \\ {\dot{Θ}}^{pre} ( k / k - 1 )\end{matrix} ] = F \cdot \hat{x} ( k - 1 / k - 1 )$$
$$and$$
$${x}^{pre} ( k / k - 1 ) = [ \begin{matrix}{Θ}^{pre} ( k / k - 1 ) \\ {\dot{Θ}}^{pre} ( k / k - 1 ) \\ {a}^{pre} ( k / k - 1 ) \\ {\dot{a}}^{pre} ( k / k - 1 )\end{matrix} ] = F \cdot \hat{x} ( k - 1 / k - 1 )$$
for the bearing trace, a predicted bearing angle (Θ^{pre}(k/k−1)) and its estimated rate of change or bearing rate (\dot{Θ}^{pre}(k/k−1)) and possibly a predicted intensity (a^{pre}(k/k−1)) and its rate of change (\dot{Θ}^{pre}(k/k−1)) are determined, corresponding to a linear subelement of a bearing trace from a trace vector (\hat{x}(k−1/k−1)) determined most recently at the time t=k−1 with the bearing angle (\hat{Θ}(k−1/k−1)) and possibly the trace intensity (â(k−1/k−1)) and the most recently determined bearing rate ({dot over (\hat{Θ}(k−1/k−1)) or intensity rate (\dot{â}(k−1/k−1)) multiplied by the clock cycle (T), to give:
Θ^{pre}(k/k−1)=\hat{Θ}(k−1/k−1)+{dot over (\hat{Θ}(k−1/k−1)·T
\dot{Θ}^{pre}(k/k−1)={dot over (\hat{Θ}(k−1/k−1)
and possibly
a^{pre}(k/k−1)=\hat{a}(k−1/k−1)+\dot{â}(k−1/k−1)·T
\dot{a}^{pre}(k/k−1)=\dot{â}(k−1/k−1),
in that, in a separation calculation stage (6) which is arranged downstream from the prediction stage (5.1) of the Kalman filter (5), association probabilities are determined of an association between the measured values (z(k)), measured at the time t=k, with measurement errors (σ_{Θ}^{2meas} and σₐ^{2meas}) of a measurement covariance matrix and the predicted state vectors (x^{pre}(k/k−1)) with the predicted bearing angles (Θ^{pre}(k/k−1)) and possibly intensities (â^{pre}(k/k−1)) with estimation errors (P^{pre}(k/k−1)) by determining a squared, normalized separation (d₁²) between the difference (y) between the measurement vector (z(k)) and the predicted state vector with respect to the sum (S) of their errors,
in that the separation calculation stage (6) forms the feedback path from the Kalman filter (5) via a measurement data association stage (8), to a filter stage (5.2) of the Kalman filter (5),
in that a trace vector (\hat{z}(k)) for the time t=k for each bearing trace \hat{x}(k/k)=x^{pre}(k/k−1)+K(k)[z(k)−Hx^{pre}(k/k−1)] is estimated in the filter stage (5.2) from the predicted state vector (x^{pre}(k/k−1)) and its estimation error (P^{pre}(k/k−1)) and the measured values (z^{meas}(k)) and their measurement covariance matrix (R) using the measurement matrix
$$H = [ \begin{matrix}1 & 0 & 0 & 0 \\ 0 & 0 & 1 & 0\end{matrix} ]$$
and the matrix
K(k)=P^{pre}(k/k−1)H^{T}[H·P^{pre}(k/k−1)·H^{T}+R]⁻¹
and the covariance matrix of the trace error is determined to be:
\hat{P}(k/k)=[I−K(k)H]·P^{pre}(k/k−1)·[I−K(k)H]^{T}+K(k)·R·K(k)^{T}
with the unit matrix I,
in that the next predicted state vector (x^{pre}(k+1/k)) and the next predicted estimation error (P^{pre}(k+1/k)) are predicted therefrom in the next clock cycle for the time t=k+1 in the prediction stage (5.1) of the Kalman filter (5).

16. Direction-finding installation according to claim 14, characterized in that, in order to determine the association probability of an association of the measured value (z(k)) measured at the time (k) with the measurement error (R) and the predicted state vector (x^{pre}(k/k−1)) and estimation error (P^{pre}(k/k−1)), the separation calculation stage (6) is followed by a trace quality calculator (9) having a calculation stage (11) provided on the input side in order to calculate the likelihood quotient as the trace quality (L), the detection probability (P_{D}) and false alarm probability (P_{FA}) of a bearing angle in the angle separation (ΔΘ) of the main reception direction of two adjacent directional characteristics are predetermined at the further inputs thereof, and a downstream bound comparison device (12), at whose inputs probabilities α and β are predetermined for confirmation of a false trace or deletion of a true trace, in that the trace quality (L) at the output of the calculation stage (11) is compared in the bound comparison device (12) with an upper and a lower bound (T₂, T₁) for addition of the bearing angle (\hat{Θ}(k/k)) and possibly the trace intensity (â(k/k)) to form a provisional and/or confirmed bearing trace, in order to initiate a new bearing trace or in order to delete the bearing trace, in that the bearing angles (\hat{Θ}(k/k)) and possibly trace intensities (â(k/k)) at the output of the Kalman filter (5), together with the output signal from the bound comparison arrangement (12) for the associated trace qualities (L) are passed to a register (13) for bearing traces, in that bearing angle (Θ(k/k)) and possibly trace intensity (a(k/k)) is connected via a port (14), which can be controlled by the bound comparison arrangement (12), to the display means (4) on which the bearing traces are displayed.

17. Direction-finding installation according to claim 14, characterized in that a squared, normalized statistical separation (d²(k/k−1))
d²(k/k−1)=y^{T}(k/k−1)·S⁻¹(k/k−1)·y(k/k−1) where
y(k/k−1)=z(k)−H\hat{x}^{pre}(k/k−1)
is determined in the separation calculation stage (6) for testing the association probability of the association of a measured bearing angle (Θ^{meas}(k)) and possibly a measured intensity (a^{meas}(k)) to form a bearing trace using the global nearest neighbor method, wherein the squared bearing angle difference is related to the error sum (S(k/k−1)) of the measurement error (R) and the estimation error (P^{pre}(k/k−1)) predicted from t=k−1 to t=k, and the probability of the association is a maximum when the squared, normalized statistical separation (d²) is a minimum.

18. Direction-finding installation according to claim 17, characterized in that a gate circuit (7) is provided between the separation calculation stage (6) and the measurement data association stage (8), for comparison of the squared normalized statistical separation (d²) between the measured value and the predicted estimated value with a predeterminable gate value, in that the gate circuit (7) prevents the squared, normalized statistical separation (d²) being passed on at the output of the separation calculation stage (6) if this separation is greater than a predetermined gate value, in that the gate value G is determined using:
$$G = 2 \cdot ln \frac{{P}_{D} \cdot ΔΘ}{( 1 - {P}_{D} ) \cdot {( 2 π )}^{M / 2} {P}_{FA} \sqrt{\vert S \vert}}$$
by presetting a detection probability (P_{D}) for a real bearing angle in the angle separation (ΔΘ) of the main reception direction of two adjacent directional characteristics and a false alarm probability (P_{FA}) taking account of the sum of the squared measurement error (σ_{Θ}^{2meas}) and estimation error (P_{Θ}^{pre}(k/k−1)), where M denotes a measurement vector dimensionality, where M=1, 2, 3 . . . .
